(19) United States
(12) Patent Application Publication
(10) Pub. No.: US 2018/0267356 A1
(43) Pub. Date: Sep. 20, 2018

(54) METHOD AND APPARATUS FOR CONTINUOUSLY MANUFACTURING OPTICAL DISPLAY DEVICE

(71) Applicant: NITTO DENKO CORPORATION, Ibaraki-shi, Osaka (JP)

(72) Inventors: Satoshi HASHIMOTO, Ibaraki-shi (JP); Kazuo KITADA, Ibaraki-shi (JP)

(73) Assignee: NITTO DENKO CORPORATION, Osaka (JP)

(21) Appl. No.: 15/760,991

(22) PCT Filed: Nov. 4, 2015
(86) PCT No.: PCT/JP2015/080981

§ 371 Date: Mar. 16, 2018

(30) Foreign Application Priority Data
Sep. 16, 2015 (JP) 2015-182743

(51) Int. Cl. G02F 1/1335; G09F 9/35; G02B 5/30; G02F 1/13; B29D 11/00

(52) U.S. Cl. CPC G02F 1/133528; G09F 9/35; G02B 5/3033; G02F 1/133509; G02F 2202/28; B29D 11/0073; G02F 2202/22; B32B 2457/202; G02F 1/1303

(57) ABSTRACT

A method for continuously manufacturing an optical display device includes air filtering into a laminating part in an apparatus, exhausting in coordination with the air filtering, and humidifying the laminating part so as to make relative humidity of the laminating part as 60 to 75% RH at room temperature 22° C. The method also includes sequentially supplying a rectangularly formed optical functional film having a pressure-sensitive adhesive layer with a separator laminated on one of opposite surfaces of the optical functional film to a predetermined laminating position of the laminating part and conveying a rectangular panel component to the predetermined laminating position so as to correspond to the sequentially supplied optical functional film. The method further includes peeling the separator from the optical functional film leaving the pressure-sensitive adhesive layer behind and laminating the optical functional film to one of opposite surfaces of the panel component by the pressure-sensitive adhesive layer.

### TECHNICAL FIELD

The present invention relates to a method and apparatus for manufacturing an optical display device by laminating an optical functional film to a panel component.

More particularly, the present invention relates to a method and apparatus for continuously manufacturing an optical display device in which at least one isolated laminating part is formed in a humidified environment in which relative humidity is 60 to 75% RH when room temperature is 22° C. The laminating part makes up a part of the apparatus for continuously manufacturing the optical display device by laminating an optical functional film to a panel component. A rectangularly formed optical functional film with a pressure-sensitive adhesive layer is fed to a predetermined laminating position of a laminating unit positioned in the laminating part. A rectangular panel component is conveyed to the predetermined laminating position so as to correspond to the optical functional film, and aligned and laminated with each other to manufacture the optical display device.

The characteristics thereof lie in continuously manufacturing the optical display device while eliminating electrical charge of the optical display device caused by generation of static electricity in the optical functional film and/or the panel component when the optical display device is continuously manufactured. That is to say, the present invention is a method and apparatus for eliminating static electricity of the optical display device in which electrostatic amount of the optical display device statically electrified in a process of continuous manufacturing is quickly lowered in the above described humidified environment formed in the laminating part.

### BACKGROUND ART

It has been well-known that there is a risk that static electricity which an optical display device is charged may degrade and/or destruct built-in electronic components. For example, electronic components built in a liquid crystal panel comprises a field-effect transistor such as a TFT elements etc. In manufacturing a liquid crystal display device, generally, different processes as in the following are carried out to complete manufacturing in order to prevent the destruction of these electronic components caused by static electricity.

A liquid crystal panel generally has a structure with a liquid crystal layer sealed between a color filter (CF substrate) layer and a transparent electrode (TFT substrate) layer. A liquid crystal display device is completed by carrying out a process of laminating each of sheets of polarizing films on at least upper and lower surfaces of the liquid crystal panel such that a transparent axis of the polarizing film on one surface is in a crossed-Nicol arrangement with that of the other surface.

In a so-called RTP laminating method and apparatus which manufactures an optical display device by, peeling and feeding only a web of carrier film from a web of laminate comprising a rectangular optical functional film, feeding the optical functional film peeled from the web of carrier film via a releasing body positioned at a laminating unit to a predetermined laminating position of the laminating unit and aligning a rectangular panel component conveyed thereto to laminate with the optical functional film. For example, a means for preventing the optical functional film from being statically electrified due to peeling (hereinafter, referred as “peeling-charge”) the optical functional film from the web of carrier film is described in Japanese Laid-Open Patent Publication JP2012-224041A (Patent Document 1).

Specifically, Patent Document 1 discloses as that, in laminating the optical functional film to the panel component to manufacture the optical display device, amount of charges generated by frictional electrification which occurs in the web of carrier film is controlled to eventually reduce amount of peeling-charge of the optical functional film peeled from the web of carrier film by configuring the releasing body of the laminating unit with a material located at a more negative side (or positive side) than the web of carrier film in terms of a triboelectric series when the web of carrier film is charged negatively (or positively) so that static electricity in the optical functional film generated by peeling operation when the optical functional film is peeled from the web of carrier film does not electrically destruct electronic components built in the panel component.

A so-called sheet-type laminating method and apparatus is described in Japanese Laid-Open Patent Publication JP2004-144908A (Patent Document 2) in which a sheet of optical functional film, comprising a pressure-sensitive adhesive layer exposed after a separator, which protects the pressure-sensitive adhesive layer, is peeled from the sheet of optical functional film, is sequentially fed to a predetermined laminating position of a laminating unit that makes up a laminating part, and a rectangular panel component is conveyed so as to be aligned with the sheet of optical functional film, and sequentially laminated via the pressure-sensitive adhesive layer for continuously manufacturing an optical display device. However, it does not at all describe elimination of charges generated in the optical display device caused, for example, by peeling operation and/or friction, when the optical functional film comprising the pressure-sensitive adhesive layer exposed after the separator is peeled is laminated to the rectangular panel component for continuously manufacturing the optical display device.

However, various proposals have been made for measures to prevent charges from being generated in a rectangular panel so far. For example, Japanese Laid-Open Patent Publication JP2002-323686A (Patent Document 3) discloses as that, when a panel component is statically electrified, a plurality of base conductive plates are positioned from upstream to downstream of a conveying unit so as to eliminate static electricity which the panel component is charged while conveying the panel component, and thus to gradually eliminate static electricity from the panel component.

Such measures to prevent electrostatic destruction of electronic components built in a panel component is not limited to the RTP laminating method and/or apparatus. Various proposals have been made similarly also for the so-called sheet-type laminating method and apparatus disclosed in Patent Document 2, in which a plurality of optical functional films preliminarily formed in rectangle so as to be matched with a shape of respective panel components are provided, each of the panel components and each of the optical functional films are conveyed to the predetermined laminating position of the laminating unit, only the separator is peeled from the optical functional film, and the optical functional film is laminated to the panel component by the pressure-sensitive adhesive layer to manufacture the optical display device.

Patent Documents 4 to 6 disclose a laminated film which reduces effect of static electricity caused by charges generated by peeling operation and/or friction etc. Specifically, Patent Documents 4 to 6 disclose a conductive layer formed on a surface where a pressure-sensitive adhesive layer of the optically functional film is formed, or a pressure-sensitive adhesive layer formed of a conducive adhesive agent. All of them disclose an anti-charging layer, a conductive layer or a conductive pressure-sensitive adhesive layer formed on a web of carrier film/optically functional film, or on an optically functional film having a pressure-sensitive adhesive layer with a rectangularly formed separator.

However, since it is difficult to completely eliminate charges of a statically electrified optical functional film and/or panel component for use, it is unavoidable that an optical display device manufactured by using them is also statically electrified. Therefore, Japanese Laid-Open Patent Publication JP H3-208019A (Patent Document 7) describes what performs manufacturing of a liquid crystal display device in a steam atmosphere.

In addition, according to Japanese Patent 5197708B (Patent Document 8), there is described a continuous manufacturing method of a liquid crystal display element as that, first, providing a polarizing film having a pressure-sensitive adhesive layer in a dry environment, then, providing a liquid crystal panel in a first wet environment in which relative humidity is higher than that of in the dry environment, and finally, laminating the polarizing film to the liquid crystal panel by a pressure-sensitive adhesive layer in a second wet environment in which relative humidity is higher than that of in the dry environment

Further, Japanese Laid-Open Patent Publication JP2008-084789A (Patent Document 9) discloses an apparatus to eliminate static electricity by neutralizing charges in a charged body, specifically, an apparatus for eliminating static electricity comprising a nozzle to atomize water to spray toward the charged body.

### PRIOR ART DOCUMENTS:

### Patent Documents

Patent Document 1: Japanese Laid-Open Patent Publication JP2012-224041A

Patent Document 2: Japanese Laid-Open Patent Publication JP2004-144908A

Patent Document 3: Japanese Laid-Open Patent Publication JP2002-323686A

Patent Document 4: Japanese Patent 4355215B

Patent Document 5: Japanese Laid-Open Patent Publication JP2001-318230A

Patent Document 6: Japanese Laid-Open Patent Publication JP2002-022960A

Patent Document 7: Japanese Laid-Open Patent Publication JP H3-208019A

Patent Document 8: Japanese Patent 5197708B

Patent Document 9: Japanese Laid-Open Patent Publication JP2008-084789A

### DISCLOSURE OF THE INVENTION

### Problem to be Solved by the Invention

The present invention challenges technical problems of, eliminating charges of a statically electrified optical display device quickly in a humidified environment and/or preventing generation of wetting caused by minute water droplets on such occasion, or eliminating charges of the statically electrified optical display device while controlling the generation of wetting, when the optical display device continuously manufactured by sheet type lamination or RTP lamination is statically electrified in a continuous manufacturing process.

### Means for Solving the Problem

The technical problems of the present invention may be solved as follows. A laminating part that makes up a part of an apparatus for continuously manufacturing an optical display device by laminating an optical functional film to a panel component. The laminating part forms an isolated space comprising air filtration means having an intake mechanism which takes in outside air inside and a filtration membrane, and an exhausting means which is installed in relation with the air filtration means to exhaust inside air outside. Humidity inside of the laminating part is set forth so as to make relative humidity as 60 to 75% RH at room temperature 22° C. The optical functional film is continuously laminated to one of opposite surfaces of the panel component sequentially conveyed to the laminating part humidified as such, or the optical functional film sequentially conveyed to the laminating part is continuously laminated one of opposite surfaces of the panel component sequentially conveyed to the laminating part.

The first aspect of the present invention is a method for continuously manufacturing an optical display device 6 as follows. A laminating part 100 makes up a part of an apparatus 10′ for continuously manufacturing the optical display device by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The method at least comprises the following steps. A humidifying step A is a step of humidifying the laminating part 100 so as to make relative humidity of the laminating part as 60 to 75% RH at room temperature 22° C. by a spraying means 110 equipped in the laminating part 100. The spraying means 110 comprises a spraying mechanism 113 inside the laminating part 100. A supplying step B′ is a step of sequentially supplying B′ a rectangularly formed optical functional film 1′ having a pressure-sensitive adhesive layer 4 with a separator 2′ laminated on one of opposite surfaces of the optical functional film to a predetermined laminating position 50 of the laminating part 100. A conveying step C′ is a step of conveying C′ a rectangular panel component 5 to the predetermined laminating position 50 so as to correspond to the sequentially supplied optical functional film 1′. A peeling step D′ is a step of peeling the separator 2′ from the optical functional film 1′ leaving the pressure-sensitive adhesive layer 4 behind. And a laminating step E is a step of laminating E the optical functional film 1′ to one of opposite surfaces of the panel component 5 by the pressure-sensitive adhesive layer 4.

The second aspect of the present invention is a method for continuously manufacturing an optical display device 6 as follows. A laminating part 100 makes up a part of an apparatus 10′ for continuously manufacturing the optical display device by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The method at least comprises the following steps. A humidifying step A is a step of humidifying the laminating part 100 so as to make relative humidity of the laminating part as 60 to 75% RH at room temperature 22° C. by a spraying means 110 equipped in the laminating part 100. The spraying means 110 comprises a spraying mechanism 113 inside the laminating part 100. A peeling step B is a step of sequentially peeling the optical functional film 1 having the pressure-sensitive adhesive layer 4 from the web of carrier film 2 via a peeling mechanism 60 positioned in proximity to a predetermined laminating position 50 of the laminating part 100, by feeding a web of laminate 11 that comprises at least a web of carrier film 2 and a plurality of optical functional films 1 with pressure-sensitive adhesive layers 4 rectangularly formed by forming slit lines 010 in a width direction on one of opposite surfaces of the web of carrier film 2. A supplying step C is a step of sequentially supplying the sequentially peeled optical functional film 1 with the pressure-sensitive adhesive layer 4 to the predetermined laminating position 50. A supplying step D is a step of conveying a rectangular panel component 5 to the predetermined laminating position 50 so as to correspond to the sequentially supplied optical functional film 1 with the pressure-sensitive adhesive layer 4. And a laminating step E is a step of laminating the optical functional film 1 to one of opposite surfaces of the panel component 5 by the pressure-sensitive adhesive layer 4.

In the first or second aspect of the invention, the humidifying step A may further comprise a step of spraying minute water droplets to the laminating part 100 at 0.02 to 0.05 L/min, in which a maximum particle size is 50 μm or less and an average particle size is 10 μm or less.

The third aspect of the present invention is a method for continuously manufacturing an optical display device 6 as follows. A laminating part 100 makes up a part of an apparatus 10 for continuously manufacturing the optical display device 6 by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The method at least comprises the following steps. A humidifying step A is a step of humidifying the laminating part 100 so as to make relative humidity of the laminating part 100 as 60 to 75% RH at room temperature 22° C. by a first vaporizing and humidifying means 140 equipped in the laminating part 100. The first vaporizing and humidifying means 140 comprises a spraying mechanism 113 inside the laminating part 100 combined with a blowing mechanism 114 and a second filtration membrane 115. A supplying step B′ is a step of sequentially supplying a rectangularly formed optical functional film 1′ having a pressure-sensitive adhesive layer with a separator 2′ laminated on one of opposite surfaces of the optical functional film to a predetermined laminating position 50 of the laminating part 100. A conveying step C′ is a step of conveying a rectangular panel component 5 to the predetermined laminating position 50 so as to correspond to the sequentially supplied optical functional film 1′. A peeling step D′ is a step of peeling the separator 2′ from the optical functional film 1′ leaving the pressure-sensitive adhesive layer 4 behind. And a laminating step E is a step of laminating the optical functional film 1′ to one of opposite surfaces of the panel component 5′ by the pressure-sensitive adhesive layer 4.

The fourth aspect of the present invention is a method for continuously manufacturing an optical display device 6 as follows. A laminating part 100 makes up a part of an apparatus 10 for continuously manufacturing the optical display device 6 by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The method at least comprises the following steps. A humidifying step A is a step of humidifying the laminating part 100 so as to make relative humidity of the laminating part 100 as 60 to 75% RH at room temperature 22° C. by a first vaporizing and humidifying means 140 equipped in the laminating part 100. The first vaporizing and humidifying means 140 comprises a spraying mechanism 113 inside the laminating part 100 combined with a blowing mechanism 114 and a second filtration membrane 115. A peeling step B is a step of sequentially peeling the optical functional film 1 having pressure-sensitive adhesive layers 4 from the web of carrier film 2 via a peeling mechanism 60 positioned in proximity to the predetermined laminating position 50 of the laminating part 100, by feeding a web of laminate that comprises at least a web of carrier film 11 and a plurality of optical functional films 1 with pressure-sensitive adhesive layers 4 rectangularly formed by forming slit lines 010 in a width direction on one of opposite surfaces of the web of carrier film 2. A supplying step C is a step of sequentially supplying the sequentially peeled optical functional film 1 having the pressure-sensitive adhesive layer 4 to the predetermined laminating position 50. A conveying step D is a step of conveying a rectangular panel component 5 to the predetermined laminating position 50 so as to correspond to the sequentially supplied optical functional film 1 having x the pressure-sensitive adhesive layer 4. And a laminating step E is a step of laminating the optical functional film 1 to one of opposite surfaces of the panel component by the pressure-sensitive adhesive layer 4.

In the third or fourth aspect of the invention, the humidifying step A further comprises a spraying step F of spraying minute water droplets to the laminating part 100 at 0.02 to 0.05 L/min, in which a maximum particle size is 50 μm or less and an average particle size is 10 μm or less. In the step F, the first vaporizing and humidifying means 140 sprays the minute water droplets 20 to the laminating part 100 by the spraying mechanism 113 by controlling the supply of water, filters the minute water droplets 20 that are blown to the laminating part 100 by the blowing mechanism 114 via the second filtration membrane 115, and vaporizes the minute water droplets 20 that are filtered and adhered to the second filtration membrane 115 by the blowing mechanism 114 so that the laminating part 100 may have relative humidity of 60 to 75% RH at room temperature 22° C.

The fifth aspect of the present invention is a method for continuously manufacturing an optical display device 6 as follows. A laminating part 100 makes up a part of an apparatus 10′ for continuously manufacturing the optical display device 6 by laminating an optical functional film 1′ to a panel component 5, and forms an isolated space that comprises an air filtration means 120 having an intake mechanism 121 which takes in outside air inside and a first filtration membrane 122, and an exhausting means 130 which is installed in relation with the air filtration means 120 to exhaust inside air outside. The method at least comprises the following steps. A humidifying step A is a step of humidifying the laminating part 100 so as to make relative humidity of the laminating part 100 as 60 to 75% RH at room temperature 22° C. by a second vaporizing and humidifying means 150 equipped in the laminating part 100, wherein the second vaporizing and humidifying means 150 comprises a spraying mechanism 113 inside the laminating part 100, combined with a suctioning mechanism 116 and a second filtration membrane 115. A supplying step B′ is a step of sequentially supplying a rectangularly formed optical functional film 1′ having a pressure-sensitive adhesive layer 4 with a separator 2′ laminated on one of opposite surfaces of the optical functional film to a predetermined laminating position 50 of the laminating part 100. A conveying step C′ is a step of conveying a rectangular panel component 5 to the predetermined laminating position 50 so as to correspond to the sequentially supplied optical functional film 1′. A peeling step D′ is a step of peeling the separator 2′ from the optical functional film 1′ leaving the pressure-sensitive adhesive layer 4 behind, and a laminating step E is a step of laminating the optical functional film 1′ to one of opposite surfaces of the panel component 5 by the pressure-sensitive adhesive layer 4.

The sixth aspect of the present invention is a method for continuously manufacturing an optical display device 6 as follows. A laminating part 100 makes up a part of an apparatus 10 for continuously manufacturing the optical display device 6 by laminating an optical functional film 1 to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside, the method at least comprises the following steps. A humidifying step A is a step of humidifying the laminating part 100 so as to make relative humidity of the laminating part 100 as 60 to 75% RH at room temperature 22° C. by a second vaporizing and humidifying means 150 equipped in the laminating part 100, wherein the second vaporizing and humidifying means 150 comprises a spraying mechanism 113 inside the laminating part 100, combined with a suctioning mechanism 116 and a second filtration membrane 115. A peeling step B is a step of sequentially peeling the optical functional film 1 having the pressure-sensitive adhesive layer 4 from the web of carrier film 2 via a peeling mechanism 60 positioned in proximity to the predetermined laminating position 50 of the laminating part 100, by feeding a web of laminate 11 that comprises at least a web of carrier film 2 and a plurality of optical functional films 1 with pressure-sensitive adhesive layers 4 rectangularly formed by forming slit lines 010 in a width direction on one of opposite surfaces of the web of carrier film 2. A supplying step C is a step of sequentially supplying the sequentially peeled optical functional film 1 with the pressure-sensitive adhesive layer 4 to the predetermined laminating position 50. A conveying step D is a step of conveying a rectangular panel component 5 to the predetermined laminating position 50 so as to correspond to the sequentially supplied optical functional film 1 with the pressure-sensitive adhesive layer 4. And a laminating step E is a step of laminating the optical functional film 1 to one of opposite surfaces of the panel component 5 by the pressure-sensitive adhesive layer 4.

In the fifth or sixth aspect of the invention, the humidifying step A further comprises a spraying step F of spraying minute water droplets to the laminating part 100 at 0.02 to 0.05 L/min, in which a maximum particle size is 50 μm or less and an average particle size is 10 μm or less. In the step F, the second vaporizing and humidifying means 150 sprays the minute water droplets 20 to the laminating part 100 by the spraying mechanism 113 by controlling the supply of water, filters the minute water droplets 20 that are taken in to the laminating part 100 by the suctioning mechanism 116 via the second filtration membrane 115, and vaporizes the minute water droplets 20 that are filtered and adhered to the second filtration membrane 115 by the suctioning mechanism 116 so that the laminating part 100 may have relative humidity of 60 to 75% RH at room temperature 22° C.

The seventh aspect of the present invention is a method for continuously manufacturing an optical display device 6 as follows. A laminating part 100 makes up a part of an apparatus 10′ for continuously manufacturing the optical display device 6 by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The method at least comprises the following steps. A humidifying step A is a step of humidifying the laminating part 100 so as to make relative humidity of the laminating part 100 as 60 to 75% RH at room temperature 22° C. by a third vaporizing and humidifying means 170 equipped outside the laminating part 100.The third vaporizing and humidifying means 170 comprises a spraying mechanism 113 outside the laminating part 100, activated in relation with the air filtration means 120. A supplying step B′ is a step of sequentially supplying a rectangularly formed optical functional film 1′ having a pressure-sensitive adhesive layer 4 with a separator 2′ laminated on one of opposite surfaces of the optical functional film to a predetermined laminating position 50 of the laminating part 100. A conveying step C′ of conveying a rectangular panel component 5 to the predetermined laminating position 50 so as to correspond to the sequentially supplied optical functional film 1′. A peeling step D′ is a step of peeling the separator 2′ from the optical functional film 1′ leaving the pressure-sensitive adhesive layer 4 behind. And a laminating step E is a step of laminating the optical functional film 1′ to one of opposite surfaces of the panel component 5 by the pressure-sensitive adhesive layer 4.

The eighth aspect of the present invention is a method for continuously manufacturing an optical display device 6 as follows. A laminating part 100 that makes up a part of an apparatus 10 for continuously manufacturing the optical display device 6 by laminating an optical functional film 1 to a panel component 5, and which forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The method at least comprises the following steps. A humidifying step A is a step of humidifying the laminating part 100 so as to make relative humidity of the laminating part 100 as 60 to 75% RH at room temperature 22° C. by a third vaporizing and humidifying means 170 equipped outside the laminating part 100. The third vaporizing and humidifying means 170 comprises a spraying mechanism 113 outside the laminating part 100, activated in relation with the air filtration means 120. A peeling step B is a step of sequentially peeling the optical functional film 1 having the pressure-sensitive adhesive layer 4 from the web of carrier film 2 via a peeling mechanism 60 positioned in proximity to the predetermined laminating position 50 of the laminating part 100, by feeding a web of laminate 11 that comprises at least a web of carrier film 2 and a plurality of optical functional films 1 with pressure-sensitive adhesive layers 4 rectangularly formed by forming slit lines 010 in a width direction on one of opposite surfaces of the web of carrier film 2. A supplying step C of sequentially supplying the sequentially peeled optical functional film 1 with the pressure-sensitive adhesive layer 4 to the predetermined laminating position. A conveying step D is a step of conveying a rectangular panel component 5 to the predetermined laminating position 50 so as to correspond to the sequentially supplied optical functional film 1 with the pressure-sensitive adhesive layer 4. And a laminating step E is a step of laminating the optical functional film 1 to one of opposite surfaces of the panel component 5 by the pressure-sensitive adhesive layer 4.

In the seventh or eighth aspect of the invention, the humidifying step A further comprises a spraying step F of spraying minute water droplets to the laminating part 100 at 0.02 to 0.05 L/min, in which a maximum particle size is 50 μm or less and an average particle size is 10 μm or less. In the step F, the third vaporizing and humidifying means 170 sprays the minute water droplets 20 to the laminating part 100 by the spraying mechanism 113 by controlling the supply of water, filters the minute water droplets 20 that are taken in to the laminating part 100 by the intake mechanism 121 of the air filtration means 120 via the first filtration membrane 122 of the air filtration means 120, and vaporizes the minute water droplets 20 that are filtered and adhered to the first filtration membrane 122 by the intake mechanism 121 so that the laminating part 100 may have relative humidity of 60 to 75% RH at room temperature 22° C.

In the seventh or eighth aspect of the invention, it is preferable that intake amount by the intake mechanism 121 of the air filtration means 120 is set to 11 m³/min when the first filtration membrane 122 having mesh roughness of 0.3 μm/99.99% is used for the air filtration means 120. It is preferable that intake amount by the intake mechanism 121 of the air filtration means 120 is set to 36 m³/min when the first filtration membrane 122 having mesh roughness of 3 μm/88% is used for the air filtration means 120.

In any of the first to the eighth aspects of the invention, the panel component 5 comprises a rectangular liquid crystal panel with electric components built therein, the optical functional film 1 or the optical functional film 1′ comprises a polarizing film having a pressure-sensitive adhesive layer which is rectangularly formed so as to match with long sides or short sides of the rectangular liquid crystal panel. Each of the polarizing films are laminated to both surfaces of the liquid crystal panel in a crossed-Nicol arrangement to thereby continuously manufacture an optical display device 6.

The ninth aspect of the present invention is an apparatus 10′ for continuously manufacturing an optical display device 6 as follows. A laminating part 100 makes up a part of an apparatus 10′ for continuously manufacturing the optical display device 6 by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The apparatus 10′ at least comprises as follows. A spraying means 110 is equipped in the laminating part 100, and comprises a spraying mechanism 113 inside the laminating part 100 for humidifying the laminating part 100 so as to make relative humidity of the laminating part 100 as 60 to 75% RH at room temperature 22° C. A supplying means 200′ sequentially supplies a rectangularly formed optical functional film 1′ having a pressure-sensitive adhesive layer 4 with a separator 2′ laminated on one of opposite surfaces of the optical functional film to a predetermined laminating position 50 of the laminating part 100. A conveying means 300′ conveys a rectangular panel component 5 to the predetermined laminating position 50 so as to correspond to the sequentially supplied optical functional film 1′. A peeling means 600′ peels the separator 2′ from the optical functional film 1′ leaving the pressure-sensitive adhesive layer 4 behind. A laminating means 400 laminates the optical functional film 1′ to one of opposite surfaces of the panel component 5 by the pressure-sensitive adhesive layer 4.

The tenth aspect of the present invention is an apparatus 10 for continuously manufacturing an optical display device 6 as follows. A laminating part 100 makes up a part of an apparatus 10 for continuously manufacturing the optical display device 6 by laminating an optical functional film 1 to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The apparatus 10 at least comprises as follows. A spraying means 110 is equipped in the laminating part 100, and comprises a spraying mechanism 113 inside the laminating part 100 for humidifying the laminating part 100 so as to make relative humidity of the laminating part 100 as 60 to 75% RH at room temperature 22° C. A peeling means 600 sequentially peels the optical functional film 1 having the pressure-sensitive adhesive layer 4 from the web of carrier film 2 via a peeling mechanism 60 positioned in proximity to the predetermined laminating position 50 of the laminating part 100, by feeding a web of laminate 11 at least comprising a web of carrier film 2 and a plurality of optical functional film 1 with pressure-sensitive adhesive layers 4 rectangularly formed by forming slit lines 010 in a width direction on one of opposite surfaces of the web of carrier film 2. A supplying means 200 sequentially supplies the sequentially peeled optical functional film having the pressure-sensitive adhesive layer to the predetermined laminating position. A conveying means 300 conveys a rectangular panel component 5 to the predetermined laminating position 50 so as to correspond to the sequentially supplied optical functional film 1 having the pressure-sensitive adhesive layer 4. A laminating means 400 laminates the optical functional film 1 to one of opposite surfaces of the panel component 5 by the pressure-sensitive adhesive layer 4.

In the ninth or tenth aspect of the invention, the spraying mechanism 113 sprays minute water droplets to the laminating part 100 at 20 by 0.02 to 0.05 L/min, in which a maximum particle size is 50 μm or less and an average particle size is 10 μm or less.

The eleventh aspect of the present invention is an apparatus 10′ for continuously manufacturing an optical display device 6 as follows. A laminating part 100 makes up a part of an apparatus for continuously manufacturing the optical display device 6 by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The apparatus 10′ at least comprises as follows. A first vaporizing and humidifying means 140 is equipped in the laminating part 100, and comprises a spraying mechanism 113 inside the laminating part 100, combined with a blowing mechanism 114 and a second filtration membrane 115 for humidifying the laminating part 100 so as to make relative humidity of the laminating part 100 as 60 to 75% RH at room temperature 22° C.

A supplying means 200′ sequentially supplies a rectangularly formed optical functional film 1′ having a pressure-sensitive adhesive layer 4 with a separator 2′ laminated on one of opposite surfaces of the optical functional film to a predetermined laminating position 50 of the laminating part 100. A conveying means 300′ conveys a rectangular panel component 5 to the predetermined laminating position 50 so as to correspond to the sequentially supplied optical functional film 1′. A peeling means 600′ peels the separator 2′ from the optical functional film 1′ leaving the pressure-sensitive adhesive layer 4 behind. A laminating means 400 laminates the optical functional film 1′ to one of opposite surfaces of the panel component 5 by the pressure-sensitive adhesive layer 4.

The twelfth aspect of the present invention is an apparatus 10 for continuously manufacturing an optical display device 6 as follows. A laminating part 100 makes up a part of an apparatus 10 for continuously manufacturing the optical display device 6 by laminating an optical functional film 1 to a panel component, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The apparatus 10 at least comprises as follows. A first vaporizing and humidifying means 140 is equipped in the laminating part 100, and comprises a spraying mechanism 113 inside the laminating part 100, combined with a blowing mechanism 144 and a second filtration membrane 115 for humidifying the laminating part 100 so as to make relative humidity of the laminating part 100 as 60 to 75% RH at room temperature 22° C. A peeling means 600 sequentially peels the optical functional film 1 having the pressure-sensitive adhesive layer 4 from the web of carrier film 2 via a peeling mechanism 60 positioned in proximity to the predetermined laminating position 50 of the laminating part 100, by feeding a web of laminate 11 at least comprising a web of carrier film 2 and a plurality of optical functional film 1 with pressure-sensitive adhesive layers 4 rectangularly formed by forming slit lines 010 in a width direction on one of opposite surfaces of the web of carrier film 2. A supplying means 200 sequentially supplies the sequentially peeled optical functional film 1 with the pressure-sensitive adhesive layer 4 to the predetermined laminating position 50. A conveying means 300 conveys a rectangular panel component 5 to the predetermined laminating position so as to correspond to the sequentially supplied optical functional film 1 with the pressure-sensitive adhesive layer 4. A laminating means 400 laminates the optical functional film 1 to one of opposite surfaces of the panel component 5 by the pressure-sensitive adhesive layer 4.

In the eleventh or twelfth aspect of the invention, the spraying mechanism 113 sprays minute water droplets to the laminating part 100 at 20 by 0.02 to 0.05 L/min, in which a maximum particle size is 50 μm or less and an average particle size is 10 μm or less. The first vaporizing and humidifying means 140 comprises the spraying mechanism 113 that sprays the minute water droplets 20 to the laminating part 100 by the spraying mechanism 113 by controlling the supply of water, and filters the minute water droplets 20 blown to the laminating part 100 by the blowing mechanism 114 via the second filtration membrane 115, and vaporizes the minute water droplets 20 that are filtered and adhered to the second filtration membrane 115 by the blowing mechanism 114 so that the laminating part may have relative humidity of 60 to 75% RH at room temperature 22° C.

The thirteenth aspect of the present invention is an apparatus 10′ for continuously manufacturing an optical display device 6 as follows. A laminating part 100 makes up a part of an apparatus 10′ for continuously manufacturing the optical display device 6 by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The apparatus 10′ at least comprises as follows. A second vaporizing and humidifying means 150 is equipped in the laminating part 100, and comprising a spraying mechanism 113 inside the laminating part 100, combined with a suctioning mechanism 116 and a second filtration membrane 115 for humidifying the laminating part 100 so as to make relative humidity of the laminating part as 60 to 75% RH at room temperature 22° C. A supplying means 200′ sequentially supplies a rectangularly formed optical functional film 1′ having a pressure-sensitive adhesive layer 4 with a separator 2′ laminated on one of opposite surfaces of the optical functional film to a predetermined laminating position 50 of the laminating part 100. A conveying means 300′ conveys a rectangular panel component 5 to the predetermined laminating position 50 so as to correspond to the sequentially supplied optical functional film 1. A peeling means 600′ peels the separator 2′ from the optical functional film 1′ leaving the pressure-sensitive adhesive layer 4 behind. And a laminating means 400 laminates the optical functional film 1′ to one of opposite surfaces of the panel component 5 by the pressure-sensitive adhesive layer 4.

The fourteenth aspect of the present invention is an apparatus 10 for continuously manufacturing an optical display device 6 as follows. A laminating part 100 makes up a part of an apparatus 10 for continuously manufacturing the optical display device 6 by laminating an optical functional film 1 to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside. The apparatus 10 at least comprises as follows. A second vaporizing and humidifying means 150 equipped in the laminating part 100, and comprising a spraying mechanism 113 inside the laminating part 100, combined with a suctioning mechanism 116 and a second filtration membrane 115 for humidifying the laminating part 100 so as to make relative humidity of the laminating part 100 as 60 to 75% RH at room temperature 22° C. A peeling means 600 sequentially peels the optical functional film 1 having the pressure-sensitive adhesive layer 4 from the web of carrier film 2 via a peeling mechanism 60 positioned in proximity to the predetermined laminating position 50 of the laminating part 100, by feeding a web of laminate 11 at least comprising a web of carrier film 2 and a plurality of optical functional film 1 having pressure-sensitive adhesive layers 4 that are rectangularly formed by forming slit lines 010 in a width direction on one of opposite surfaces of the web of carrier film 2. A supplying means 200 sequentially supplies the sequentially peeled optical functional film 1 having the pressure-sensitive adhesive layer 4 to the predetermined laminating position 50. A conveying means 300 conveys a rectangular panel component 5 to the predetermined laminating position 50 so as to correspond to the sequentially supplied optical functional film 1 having the pressure-sensitive adhesive layer 4. And a laminating means 400 laminates the optical functional film 1 to one of opposite surfaces of the panel component 5 by the pressure-sensitive adhesive layer 4.

In the thirteenth or fourteenth aspect of the invention, the spraying mechanism 113 sprays minute water droplets 20 to the laminating part 100 at 0.02 to 0.05 L/min, which a maximum particle size is 50 μm or less and an average particle size is 10 μm or less. The second vaporizing and humidifying means 150 comprises the spraying mechanism 113 that sprays the minute water droplets 20 to the laminating part 100 by the spraying mechanism 113 by controlling the supply of water, and filters the minute water droplets 20 that are taken in to the laminating part 100 by the suctioning mechanism 116 via the second filtration membrane 115, and vaporizes the minute water droplets 20 that are filtered and adhered to the second filtration membrane 115 by the suctioning mechanism 116 so that the laminating part may have relative humidity of 60 to 75% RH at room temperature 22° C.

The fifteenth aspect of the present invention is an apparatus 10′ for continuously manufacturing an optical display device 6 as follows. A laminating part 100 makes up a part of an apparatus 10′ for continuously manufacturing the optical display device 6 by laminating an optical functional film 1′ to a panel component 5, and forms an isolated space comprising an air filtration means 120 having an intake mechanism 121 which takes in outside air inside and a first filtration membrane 122, and an exhausting means 130 which is installed in relation with the air filtration means 120 to exhaust inside air outside, the apparatus 10′ at least comprising a third vaporizing and humidifying means 170 equipped outside the laminating part 100, and comprising a spraying mechanism 113 outside the laminating part 100, activated in relation with the air filtration means 120 for humidifying the laminating part 100 so as to make relative humidity of the laminating part 100 as 60 to 75% RH at room temperature 22° C. A supplying means 200′ sequentially supplies a rectangularly formed optical functional film 1′ having a pressure-sensitive adhesive layer 4 with a separator 2′ laminated on one of opposite surfaces of the optical functional film to a predetermined laminating position 50 of the laminating part 100. A conveying means 300′ conveys a rectangular panel component 5 to the predetermined laminating position 50 so as to correspond to the sequentially supplied optical functional film 1′. A peeling means 600′ peels the separator 2′ from the optical functional film 1′ leaving the pressure-sensitive adhesive layer 4 behind. And a laminating means 400 laminates the optical functional film 1′ to one of opposite surfaces of the panel component 5 by the pressure-sensitive adhesive layer 4.

The sixteenth aspect of the present invention is an apparatus 10 for continuously manufacturing an optical display device 6 as follows. A laminating part 100 makes up a part of an apparatus 10 for continuously manufacturing the optical display device 6 by laminating an optical functional film 1 to a panel component 5, and forms an isolated space comprising an air filtration means 120 having an intake mechanism 121 which takes in outside air inside and a first filtration membrane 122, and an exhausting means 130 which is installed in relation with the air filtration means to exhaust inside air outside. The apparatus 10 at least comprises as follows. A third vaporizing and humidifying means 170 is equipped outside the laminating part 100, and comprises a spraying mechanism 113 outside the laminating part 100, activated in relation with the air filtration means 120 for humidifying the laminating part 100 so as to make relative humidity of the laminating part 100 as 60 to 75% RH at room temperature 22° C. A peeling means 600 sequentially peels the optical functional film 1 having the pressure-sensitive adhesive layer 4 from the web of carrier film 2 via a peeling mechanism 60 positioned in proximity to the predetermined laminating position 50 of the laminating part 100, by feeding a web of laminate 11 at least comprising a web of carrier film 2 and a plurality of optical functional film 1 with pressure-sensitive adhesive layers 4 rectangularly formed by forming slit lines 010 in a width direction on one of opposite surfaces of the web of carrier film 2. A supplying means 200 sequentially supplies the sequentially peeled optical functional film 1 having the pressure-sensitive adhesive layer 4 to the predetermined laminating position 50. A conveying means 300 conveys a rectangular panel component 5 to the predetermined laminating position 50 so as to correspond to the sequentially supplied optical functional film 1 with the pressure-sensitive adhesive layer 4. And a laminating means 400 to laminate the optical functional film 1 to one of opposite surfaces of the panel component 5 by the pressure-sensitive adhesive layer 4.

In the fifteenth or sixteenth aspect of the invention, the spraying mechanism 113 sprays minute water droplets 20 to the laminating part 100 at 0.02 to 0.05 L/min, which a maximum particle size is 50 μm or less and an average particle size is 10 μm or less. The third vaporizing and humidifying means 170 comprises the spraying mechanism 113 sprays the minute water droplets 20 to the laminating part 100 by the spraying mechanism 113 by controlling the supply of water and filters the minute water droplets 20 taken in to the laminating part 100 by the intake mechanism 121 of the air filtration means 120 via the first filtration membrane 122 of the air filtration means 120, and vaporizes the minute water droplets 20 that are filtered and adhered to the first filtration membrane 122 by the intake mechanism 121 so that the laminating part may have relative humidity of 60 to 75% RH at room temperature 22° C.

In the fifteenth or sixteenth aspect of the invention, it is preferable that intake amount by the intake mechanism 121 of the air filtration means 120 is set to 11 m³/min when the first filtration membrane 122 having mesh roughness of 0.3 μm/99.99% is used for the air filtration means 120. It is preferable that intake amount by the intake mechanism 121 of the air filtration means 120 is set to 36 m³/min when the first filtration membrane 122 having mesh roughness of 3 μm/88% is used for the air filtration means 120.

In any of the ninth to the sixteenth aspects of the invention, the panel component 5 comprises a rectangular liquid crystal panel with electric components built therein. The optical functional film 1 or the optical functional film 1′ comprises a polarizing film having a pressure-sensitive adhesive layer which is rectangularly formed so as to match with long sides or short sides of the rectangular liquid crystal panel. Each of the polarizing films are laminated to both surfaces of the liquid crystal panel in a crossed-Nicol arrangement to thereby continuously manufacture an optical display device 6.

### BRIEF DESCRIPTION OF THE DRAWINGS

FIG. 1 is a diagrammatic illustration (a) of a RTP laminating apparatus for continuously manufacturing an optical display device seen from a side, and a simplified view (b) of a web of laminate equipped in the RTP laminating apparatus.

FIG. 2 is a diagrammatic illustration (a) of a sheet-type laminating apparatus for continuously manufacturing an optical display device seen from above, and a simplified view (b) of a laminate sheet formed in a sheet (hereinafter, referred as “a sheet-formed laminate”.

FIG. 3 is a diagrammatic illustration of a laminating part configured to correspond to Example 1 or Comparative Example 2.

FIG. 4 is a diagrammatic illustration of a laminating part configured to correspond to Example 2.

FIG. 5 is a diagrammatic illustration of a laminating part configured to correspond to Examples 3 or 4.

FIG. 6 is a diagrammatic illustration of a laminating part configured to correspond to any of Examples 5 to 7 or any of Comparative Examples 3 to 6.

FIG. 7 is a diagrammatic illustration of a laminating part configured to correspond to Comparative Example 1.

FIG. 8 is a diagrammatic illustration of a laminating part configured to correspond to Comparative Example 7.

FIG. 9 is a table illustrating a general outline of components and their functions of a laminating part configured to correspond to Examples 1 to 7 of the present invention.

FIG. 10 is a table illustrating a general outline of components and their functions of a laminating part configured to correspond to Comparative Examples 1 to 7.

FIG. 11 is a table illustrating specifications of commercially available equipment used for an air filtering means and a vaporizing and humidifying means of a laminating part.

FIG. 12 is a table illustrating details of configurations of commercially available equipment used for a first vaporizing and humidifying means and a second vaporizing and humidifying means equipped in a laminating part.

### BEST MODE FOR IMPLEMENTING THE INVENTION

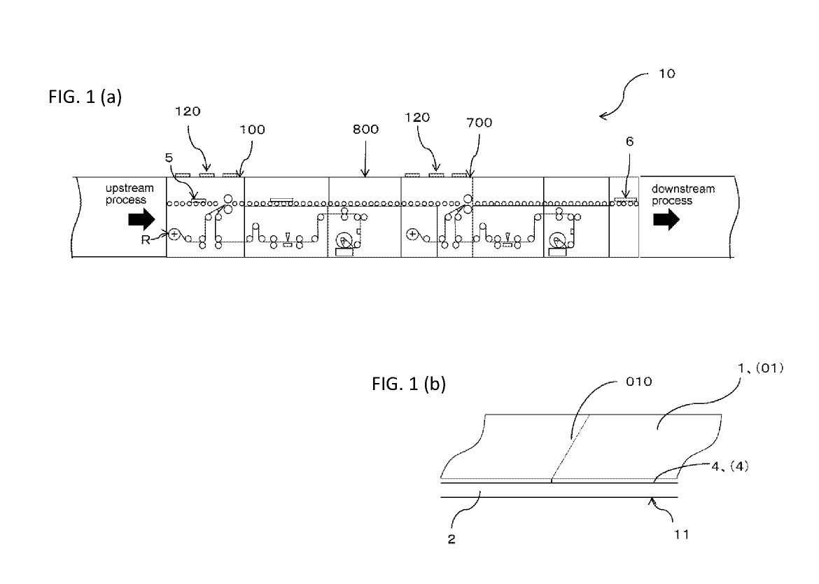

FIG. 1(a) is a diagrammatic illustration of a RTP laminating apparatus 10 for continuously manufacturing an optical display device 6 seen from a side. It is the diagrammatic illustration representing the RTP laminating apparatus 10, starting from an upstream process, next through a first laminating part 100, then by way of a rotating and reversing part 800 of a panel component, and then up to a second laminating part 700 to continue to a downstream process.

In the present apparatus 10, the optical display device 6 is manufactured through a process as follows. A web of laminate 11 at least comprised of a web of optical functional film 01 laminated on a web of carrier film 2 via a pressure-sensitive adhesive layer (4) is fed from a roll R. An optical functional film 1 having a pressure-sensitive adhesive layer 4 cut in a sheet, leaving the web of carrier film 2 behind, is laminated to at least one of opposite surfaces of a rectangular panel component 5 by the pressure-sensitive adhesive layer 4, as shown in the diagrammatic illustration of FIG. 1(a) and the simplified view of FIG. 1(b).

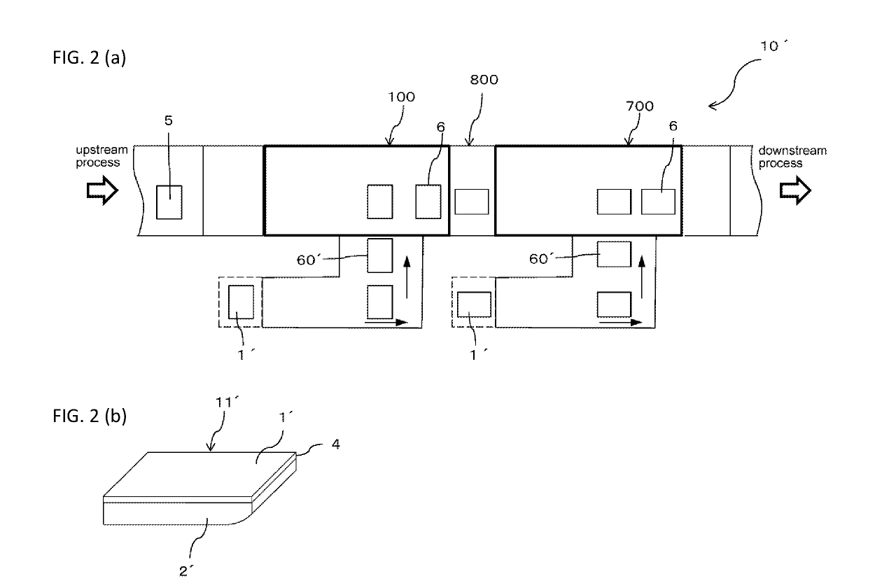

FIG. 2(a) is a diagrammatic illustration of a sheet-type laminating apparatus 10′ for continuously manufacturing an optical display device 6 seen from above. It is a diagrammatic illustration representing an apparatus also starting from an upstream process, next through a first laminating part 100, then by way of a rotating and reversing part 800 of a panel component, and then up to a second laminating part 700 to continue to a downstream process.

In the present apparatus 10′, the optical display device 6 is manufactured as shown in FIGS. 2(a) and 2(b). The pressure-sensitive adhesive layer 4 is exposed in a process of peeling a separator 2′ of a laminate sheet 11′. The laminate sheet 11′ is preliminarily formed in a sheet and sequentially supplied from a supplying part such as a magazine etc., and comprises an optical functional film 1′ having a pressure-sensitive adhesive layer 4 with the separator 2′ laminated on one of opposite surfaces of the optical functional film. Then, in a laminating process, at least one of opposite surfaces of a rectangular panel component 5, for example, is laminated to the optical functional film 1′ by the pressure-sensitive adhesive layer 4.

As described in the above, the optical display device 6 is continuously manufactured by the RTP laminating apparatus 10 or the sheet-type laminating apparatus 10′, and there is no difference in functions of the respective finished optical display devices 6.

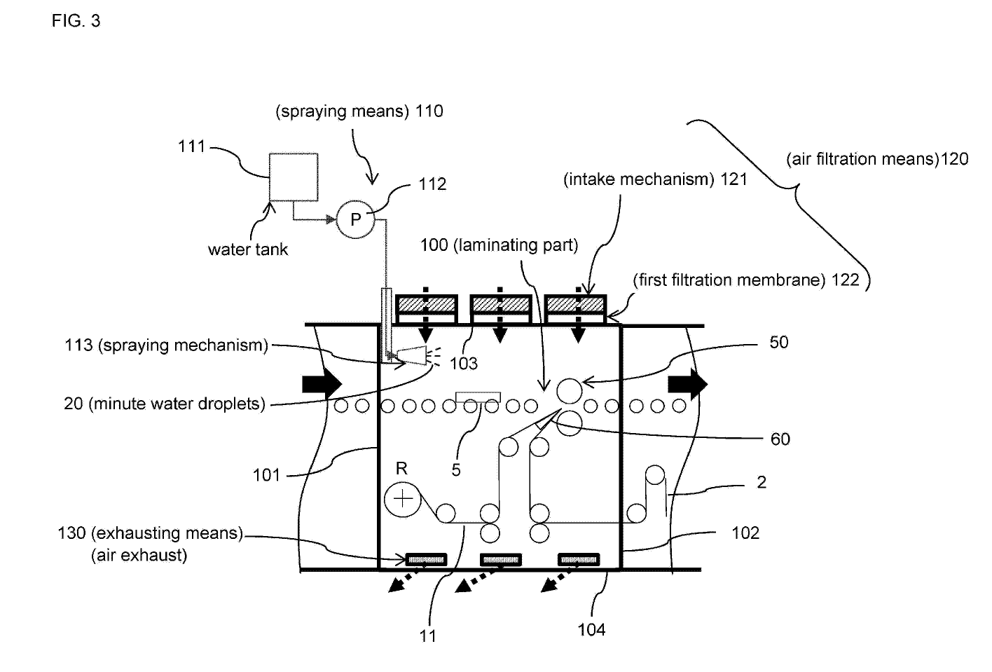

FIG. 3 is a diagrammatic illustration representing a laminating part 100 that corresponds to Example 1 or Comparative Example 2. The laminating part 100 is used for the RTP laminating apparatus 10 or the sheet-type laminating apparatus 10′ that continuously manufactures the optical display device 6 illustrated in FIG. 1 or FIG. 2. For the sake of simplicity, it comprises each of process of the RTP laminating apparatus 10, as shown by narrow lines, such as, a process of conveying the panel component 5, a process of supplying the web of laminate 11 fed from the roll R, a process of winding the web of carrier film 2 by way of a peeling mechanism 60 and a process of laminating at a predetermined laminating position 50 which is not specifically illustrated in the figure.

FIG. 3 also comprises, among each of the processes of a known sheet-type laminating apparatus 10′ an alternative to the RTP laminating apparatus 10, not illustrated, for example, a process of supplying the laminate sheet 11′ comprising the optical functional film 1′ having the pressure-sensitive layer 4 with the separator 2′ laminated on one of opposite surfaces of the optical functional film 1′ from a supplying part such as a magazine etc., a process of peeling the separator 2′ by a peeling mechanism 60′ shown in FIG. 2 and a process of laminating at a predetermined laminating position 50 not specifically illustrated in the figure.

The laminating part 100 forms an isolated space. It is preferred that sides of the apparatus parallel to a conveying direction of the panel component 5 shown by thick arrows are sealed. At the laminating part 100, an upstream side 101 crossing the conveying direction of the panel component 5 and a downstream side 102 crossing the conveying direction of the optical display device 6 which has gone through the laminating process may both be shielded with an air curtain etc., for example.

So-called HEPA Filter/Filters that makes/make up a plurality of air filtration means 120 is/are positioned on a top plate 103 of the laminating part 100 as shown in FIG. 3. A spraying mechanism 113 that makes up a spraying means 110 is installed under the top plate 103 over the conveyed panel component 5. A plurality of exhausting means 130 comprising respective air outlets are provided on a bottom plate 104 of the laminating part 100, and they can be activated in coordination with the air filtration means 120 and/or the spraying means 110.

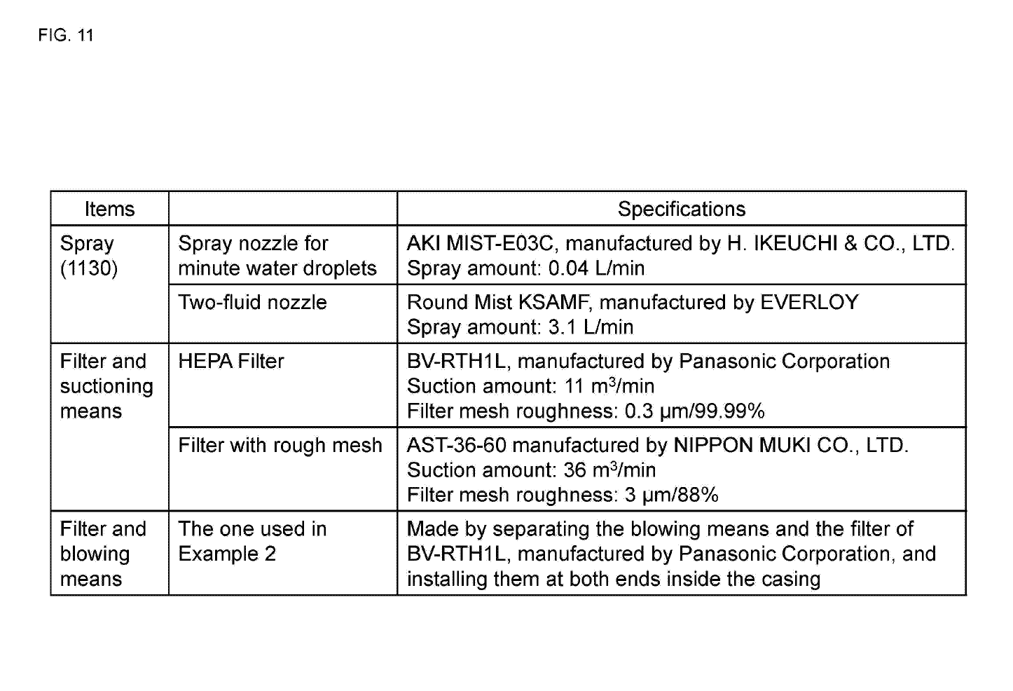

For air filtration means 120, commercially available HEPA Filter/Filters (BV-RTH1L, manufactured by Panasonic Corporation) comprising an intake mechanism 121 which suction amount per minute is set to 11 m³/min and a first filtration membrane 122 having mesh roughness of 0.3 μm/99.99% etc. is/are used, as shown in a table of FIG. 11.

For a spray 1130 of the spray mechanism 113 that makes up the spraying means 110 equipped in the laminating part 100, an also commercially available spray (AKI MIST-E03C, manufactured by H. IKEUCHI & CO., LTD.) having a spray nozzle for minute water droplets which spray amount per minute is set to 0.04 L/min etc. is used, as shown in the table of FIG. 11.

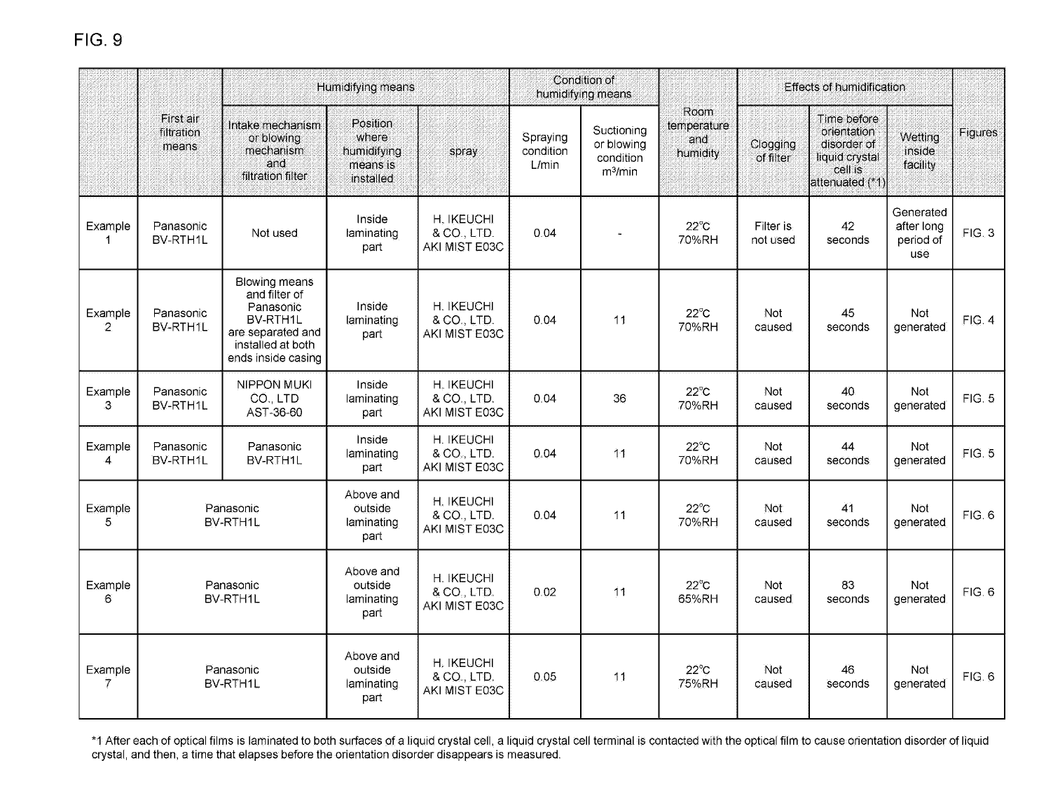

A humidified environment formed in the laminating part 100 of Example 1 is shown by items “Room temperature and humidity” and “Effects of humidification” of Example 1 contained in a table of FIG. 9. Specifically, it shows that, after laminating the optical functional film 1 or a polarizing film equivalent to the optical functional film 1′ to both surfaces of a liquid crystal cell equivalent to the panel component 5, a liquid crystal cell terminal is contacted with the polarizing film to cause orientation disorder (static electrification) of a liquid crystal. Then, a time that elapses before the orientation disorder disappears is measured to check whether the orientation disorder of the liquid crystal caused by static electrification has disappeared, i.e. whether the static electrification is attenuated (eliminated), within an appropriate time and without wetting caused by humidification inside the laminating part 100.

As apparent from the table of FIG. 9, the laminating part 100 of Example 1 has relative humidity of 70% RH at room temperature 22° C., with a spraying condition of the spraying mechanism 113 being 0.04 L/min. When this is restated with absolute humidity, a moisture amount becomes 13.6 g/m³. HEPA Filter/Filters is/are positioned on the top plate 103 of the laminating part 100, and with respect to suction condition of the intake mechanism 121 that makes up the HEPA Filter/Filters, it is set to 11 m³/min, and mesh roughness of the first filtration membrane 122 is set to 0.3 μm/99.99%.

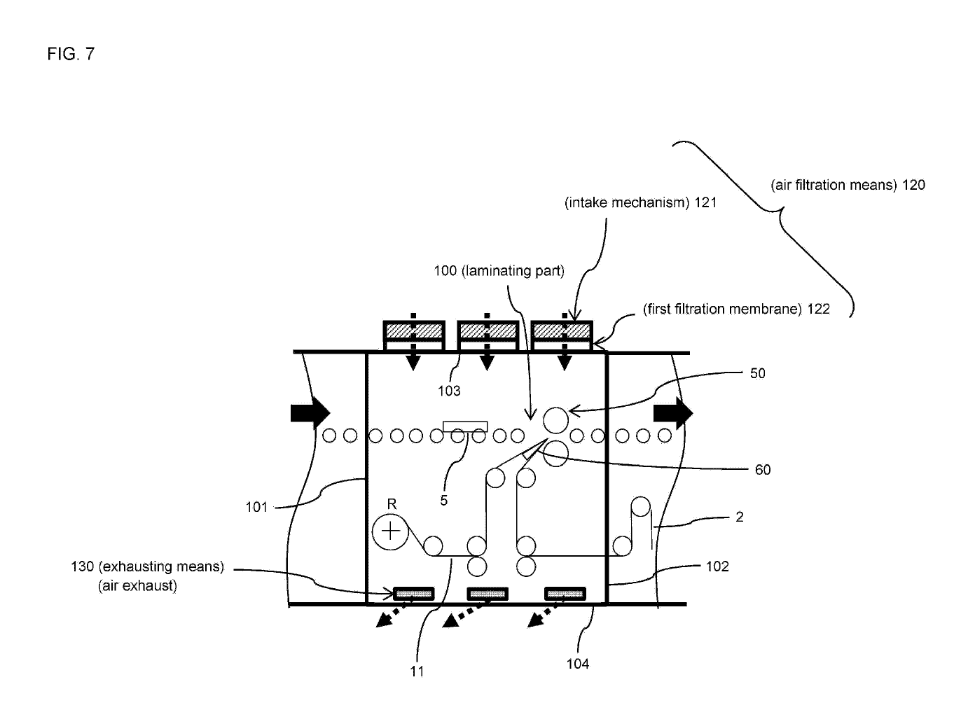

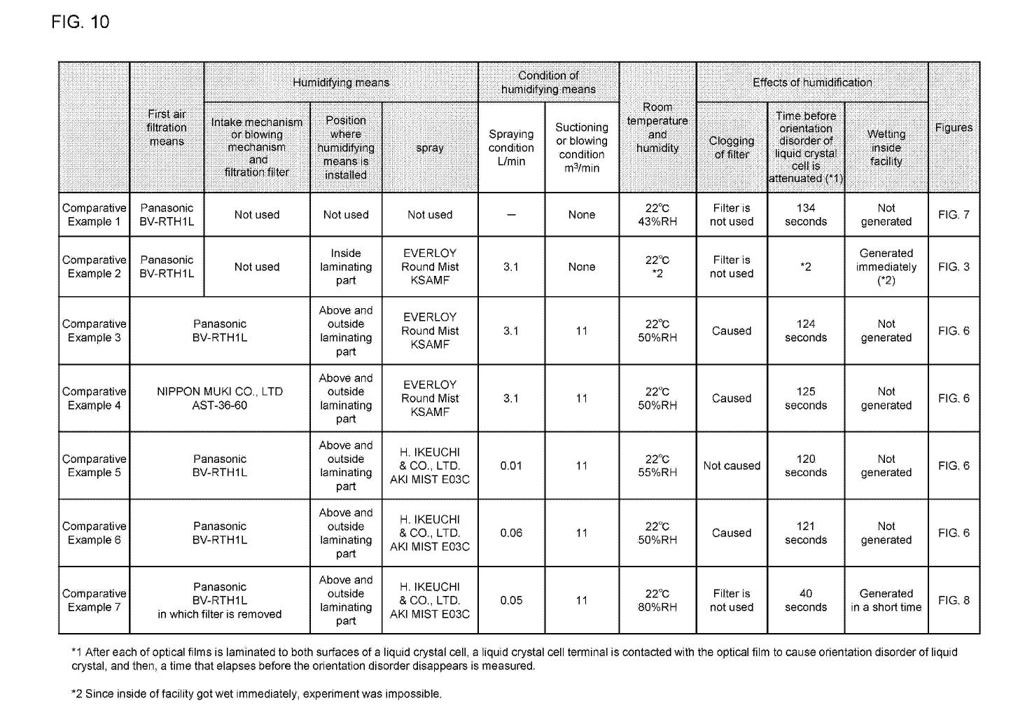

Example 1 is compared with Comparative Example 1 or 2 contained in a table of FIG. 10. FIG. 7 is a diagrammatic illustration of a laminating part 100 that makes up a part of a conventional RTP laminating apparatus 10 or a sheet-type laminating apparatus 10′ configured to correspond to Comparative Example 1. The laminating part 100 according to Comparative Example 1 deploys air filtration means 120 similar to the one in Example 1 (BV-RTH1L, manufactured by Panasonic Corporation) on a top plate 103, but a spraying means 110 comprising a spraying mechanism 113 is not deployed inside the laminating part 100 as in the case of Example 1.

A humidified environment of the laminating part 100 in Comparative Example 1 has relative humidity of 43% RH at room temperature 22° C. When compared with Example 1, naturally, wetting is not generated inside the laminating part 100 according to Comparative Example 1. However, it takes as much as 134 seconds, which is more than three times the case according to Example 1, to attenuate (eliminate) orientation disorder of a liquid crystal caused by static electrification. This value cannot be adopted in a manufacturing process for continuously manufacturing the optical display device 6.

Then, when Comparative Example 2 is considered, air filtration means 120 similar to Example 1 (BV-RTH1L, manufactured by Panasonic Corporation) is deployed on a top plate 103, and a spraying means 110 comprising a spraying mechanism 113 is deployed inside the laminating part 100 similar to the case of Example 1. The difference with Example 1 is that a commercially available spray (Round Mist KSAMF, manufactured by EVERLOY) equipped with a two-fluid nozzle is used as a spray 1130.

The two-fluid nozzle is explained here. It is a type of a fluid nozzle which applies pressure to fluid, such as liquid and/or gas which deforms with a limited force, to blow it out therefrom. The two-fluid nozzle is used to blow out compressed air and water together to make, i.e. to spray, fine droplets of water. The above described commercially available minute-water-droplet spray nozzle (AKI MIST-E03C, manufactured by H. IKEUCHI & CO., LTD.) is also a type of two-fluid nozzle, but is devised by providing a special mechanism to produce smaller water droplets than the conventional two-fluid nozzle.

In this connection, for the two-fluid nozzle of the spray 1130 in Comparative Example 2, a one having a spray amount set to 3.1 L/min (Round Mist KSAMF, manufactured by EVERLOY) shown in a table of FIG. 11 is used. When compared with the spraying condition of Example 1, its spray amount is more than 70 times greater than that of Example 1. Therefore, as shown in an item of “Effects of humidification” of FIG. 10, since wetting generated just after the spraying in the laminating part 100 according to Comparative Example 2, it was impossible to perform an experiment.

In the humidified environment of the laminating part 100 according to Example 1, it took 42 seconds for attenuating (eliminating) orientation disorder of the liquid crystal caused by static electrification, and this is not a problematic value in the manufacturing process for continuously manufacturing the optical display device. Also, wetting is not generated at the moment the humidified environment is formed. However, wetting is found inside the laminating part 100 after a long period of use such as for one day, for example.

An experiment was performed to check a level which a humidified environment should have so as to be adopted in the continuous manufacturing process of the optical display device 6. It is found out that, when relative humidity is 60% RH or less at room temperature 22° C., the inspection of the panel component 5 is disrupted, as a result that a panel component 5 fed to an inspecting process following a laminating process without the eliminating static charge enough and with orientation disorder of a liquid crystal generated. Thus, it is prone to cause a problem of obstructing continuous manufacturing of the panel component 5.

In addition, when the relative humidity is 75% RH or more at room temperature 22° C., since wetting is generated inside the laminating part 100 at the moment or in a short period of time after the humidified environment is formed, deterioration of a manufacturing apparatus 10 or a manufacturing apparatus 10′ and/or a quality problem in the panel component 5 or the optical functional film 1 or the optical functional film 1′ may arise. Therefore, it is preferable to control the relative humidity so as to be 60 to 75% RH at room temperature 22° C.

The humidified environment of the laminating part 100 which enables sufficient elimination of static electricity while preventing generation of wetting is largely influenced by performance and spraying condition of the spraying mechanism 113. It is preferable that an average particle size of each of the sprayed minute water droplets 20 is 10 μm or less. For example, if the maximum particle size is 50 μm or more, not only wetting inside the laminating part 100 is prone to be generated, but also it may be a factor to cause clogging in a filtration membrane even the spraying mechanism 113 combined with the filtration membrane, for example, is used.

Regarding the spraying condition for forming the appropriate humidified environment of the laminating part 100, the spraying condition in the case of Example 1 is 0.04 L/min. The spraying process is omitted in Comparative Example 1. Thus, in the case of Comparative Example 1, no wetting is generated inside the laminating part 100, but since it takes 134 seconds for eliminating static electricity, it is not possible to eliminate static electricity within appropriate time. Then, the case of Comparative Example 2 which spraying condition is set to 3.1 L/min is considered. At the laminating part 100 of Comparative Example 2, the air filtration means 120 (BV-RTH1L, manufactured by Panasonic Corporation) similar to the one in Example 1 are deployed on the top plate 103 of the laminating part 100 as shown in FIG. 3, but wetting is generated inside the laminating part 100 just after spraying by the spray 1130 that makes up the spraying mechanism 113. Thus, it is impossible to perform an experiment. Naturally, this spraying condition cannot be adopted in the manufacturing process for continuously manufacturing the optical display device 6.

According to the experiment, when the spraying condition is 0.02 L/min or less, the sufficient humidified condition may not be formed, thereby it is impossible to eliminate static electricity sufficiently. On the other hand, when the spraying condition is 0.05 L/min or more, even via the filtration membrane, clogging occurs. Thus, the appropriately humidified environment may not be formed. Also, if spraying is performed without the filtration membrane, excess humidification may occur and leads to an inconvenience in which wetting is generated inside the laminating part 100 just after the spraying. Therefore, it is preferable to set the spraying condition of minute water droplets 20 at 0.02 to 0.05 L/min when the average particle size is 10 μm or less as 0.02 to 0.05 L/min.

For the spray 1130 used for the spraying mechanism 113 that makes up the spraying means 110 installed under the top plate 103 over the conveyed panel component 5 inside the laminating part 100, a commercially available spray (AKI MIST-E03C, manufactured by H. IKEUCHI & CO., LTD.) is used as shown in the table of FIG. 9. Further, for the spraying mechanism 113 in Example 1, the spray 1130 which can spray minute water droplets 20 which each of the maximum particle size is 50 μm and the average particle size is 10 μm or less is used. The spray 1130 is capable of being coordinated with a water tank 111 installed outside the laminating part 100 via a supply pump 112.

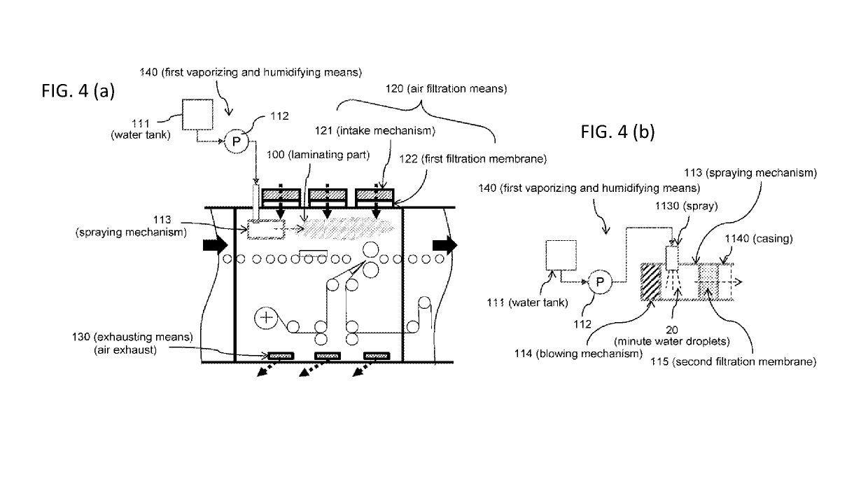

FIGS. 4 to 6 each show a diagrammatic illustration of a laminating part 100 configured to correspond to any of Examples 2 to 7, used in the RTP laminating apparatus 10 or the sheet-type laminating apparatus 10′ for continuously manufacturing the optical display device 6 of FIG. 1 or FIG. 2. Similar to what is shown by narrow lines in FIG. 3, each of FIGS. 4 to 6 comprises each process of the RTP laminating apparatus 10 shown by narrow lines for the sake of simplicity. For example, a process of conveying the panel component 5, a process of supplying the web of laminate 11 fed from the roll R, a process of winding the web of carrier film 2 by way of a peeling mechanism 60 and a process of laminating at a predetermined laminating position 50 not specifically illustrated in the figure. It also comprises, among each of the processes of the known sheet-type laminating apparatus 10′ that is an alternative to the RTP laminating apparatus 10, not illustrated, for example, a process of supplying the laminate sheet 11′ which is supplied from a supplying part such as a magazine and configured by the optical functional film 1′ having the pressure-sensitive layer 4 with a separator 2′ laminated on one of opposite surfaces of the optical functional film 1′, a process of peeling the separator 2′ and a process of laminating at a predetermined laminating position 50 not specifically illustrated in the figure.

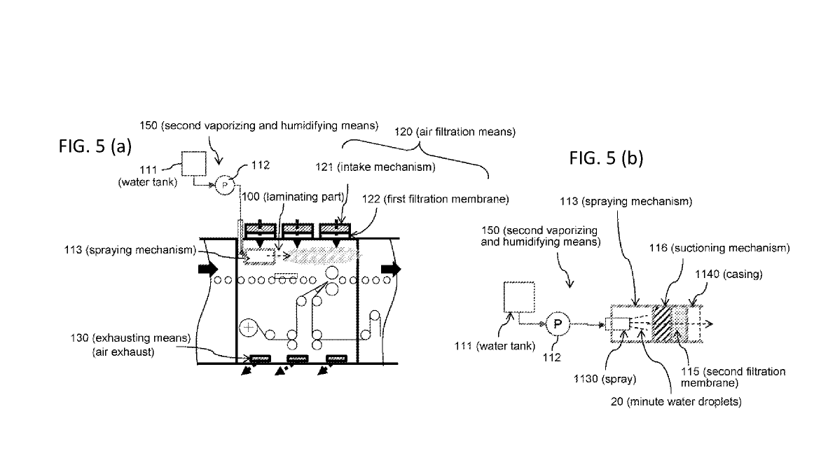

FIGS. 4(a) and 4(b) are diagrammatic illustrations respectively representing a laminating part 100 configured to correspond to Example 2, and a first vaporizing and humidifying means 140 equipped in the laminating part 100. In addition, FIGS. 5(a) and 5(b) are diagrammatic illustrations respectively representing a laminating part 100 configured to correspond to Examples 3 or 4, and a second vaporizing and humidifying means 150 equipped in the laminating part 100.

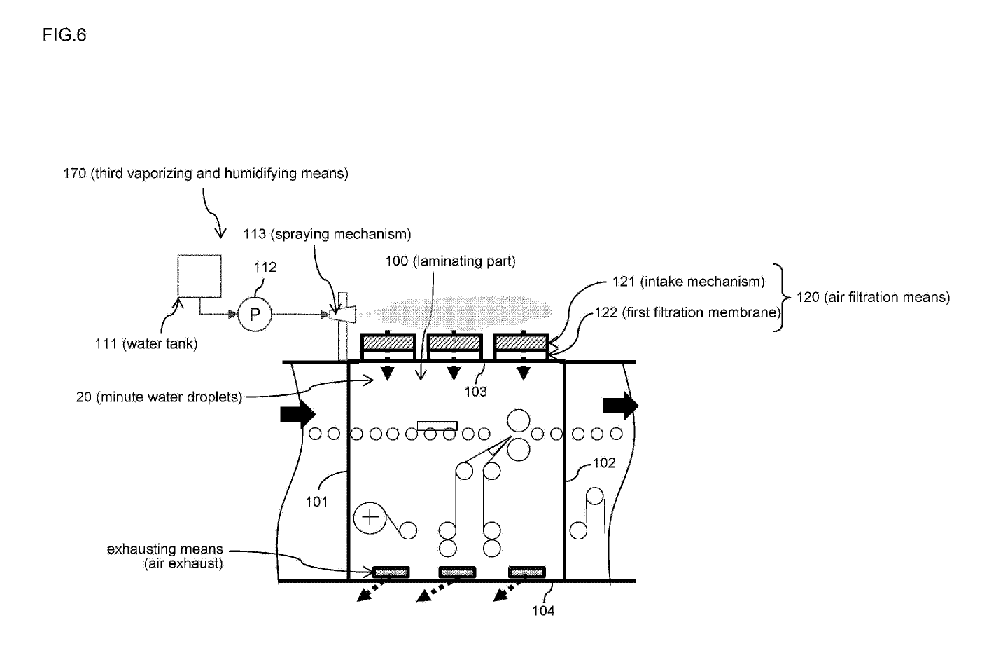

FIG. 6 is a diagrammatic illustration representing a laminating part 100 configured to correspond to any of Examples 5 to 7 or any of Comparative Examples 3 to 6. While details are described in the following, each of the laminating parts 100 of the above Examples and Comparative Examples is not equipped with a vaporizing and humidifying means corresponding to the first vaporizing and humidifying means 140 equipped in the laminating part 100 according to Example 2, or the second vaporizing and humidifying means 150 equipped in the laminating part 100 according to Examples 3 or 4.

When Examples 2 to 4 are considered, the first vaporizing and humidifying means 140 and the second vaporizing and humidifying means 150 are both means corresponding to the spraying means 110 equipped in the laminating part 100 configured to correspond to Example 1. As apparent from FIG. 4 or 5, a plurality of air filtration means 120, i.e., HEPA Filter/Filters is/are positioned above the top plate of the laminating part 100 for the laminating part 100 according to Example 2 and also for the laminating part 100 according to Examples 3 or 4. It is completely the same as the laminating part 100 according to Example 1.

In addition, a plurality of exhausting means 130 respectively comprising air outlet(s) is provided on a bottom plate 104 of the laminating part 100 according to Example 2, as well as on that of the laminating part 100 according to Examples 3 or 4, similar to the case according to Example 1. They are activated in coordination with the air filtration means 120, and furthermore, they can be activated in coordination with the first vaporizing and humidifying means 140 or the second vaporizing and humidifying means 150.

On the other hand, a vaporizing and humidifying means that would correspond to the spraying means 110 equipped in the laminating part 100 according to Example 1 is equipped under the top plate 103 which is over the conveyed panel component 5. The vaporizing and humidifying means according to Example 2 is the first vaporizing and humidifying means 140, and the vaporizing and humidifying means according to Examples 3 or 4 is the second vaporizing and humidifying means 150.

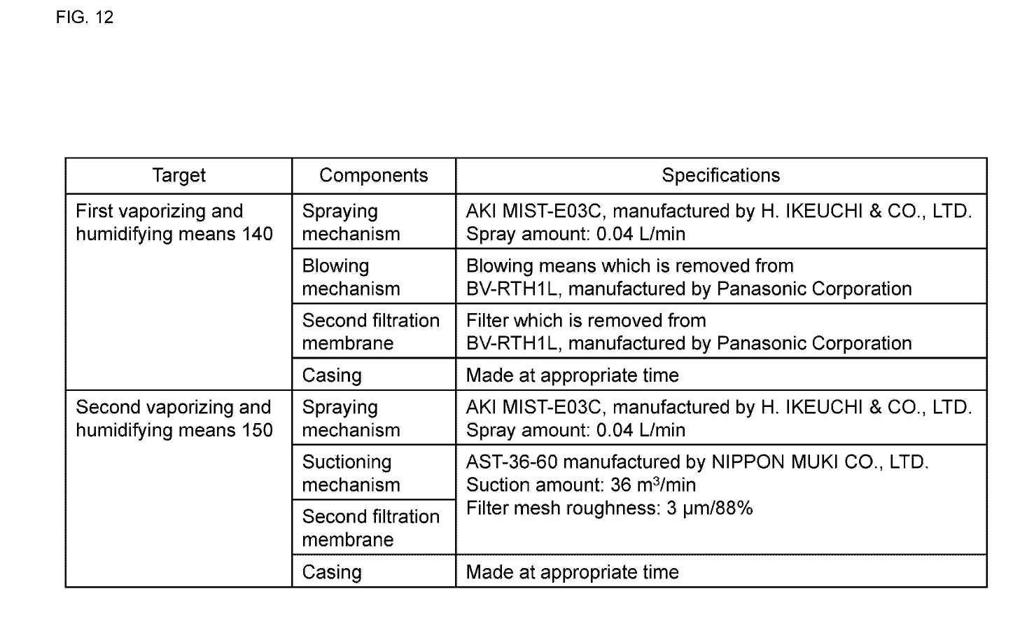

For each of the first vaporizing and humidifying means 140 and the second vaporizing and humidifying means 150, a spraying mechanism 113 is installed inside the laminating part 100 so as to correspond with the spraying mechanism 113 of the spraying means 110. However, while the spraying mechanism 113 of the spraying means 110 is configured only by the spray 1130, the spraying mechanism 113 of the first vaporizing and humidifying means 140 has a casing 1140 in which the spray 1130, and a blowing mechanism 114 and a second filtration membrane 115 that are activated in coordination with the spray 1130 are located. In addition, the spraying mechanism 113 of the second vaporizing and humidifying means 150 has a casing 1140 in which the spray 1130, and a suctioning mechanism 116 and a second filtration membrane 115 which are activated in coordination with the spray 1130 are located. Detailed configurations of both of the commercially available equipment are shown in FIG. 12.

When the spraying conditions for the cases according to Examples 2 to 4 are considered, as apparent from the table of FIG. 9, all are set to 0.04 L/min. Then, when the blowing mechanism 114 or the suctioning mechanism 116 are considered, the blowing condition of Example 2 and the suctioning condition of Example 4 are both 11 m³/min. On the other hand, the suctioning condition of Example 3 is 36 m³/min which is a value exceeding three times the value of above Examples. In spite of the fact that the condition blown or suctioned to the laminating part 100 differs greatly, since a rate of minute water droplets 20 fed to the laminating part 100 per minute are kept unchanged as 0.04 L/min, it is possible to form humidified environment in the laminating part 100 which relative humidity is 70% RH at room temperature 22° C. in all of the cases according to Examples 2 to 4.

Therefore, as apparent from the table of FIG. 9, in the humidified environments according to Example 2 and Examples 3 or 4, it takes about 40 to 45 seconds for attenuating (eliminating) static electrification of orientation disorder of the liquid crystal caused by static electrification, which is about the same as Example 1. Any of them are not problematic values in the manufacturing process for continuously manufacturing the optical display device 6, and further, different from Example 1, no wetting is generated inside the laminating part 100 even after a long period of use.

It is because the spraying mechanism 113 of the laminating part 100 according to Example 1 is provided by the spray 1130 only, whereas each of the laminating parts 100 according to Example 2 and Examples 3 or 4 provides the spraying mechanism 113 in which the blowing mechanism 114 or the suctioning mechanism 116 is combined with the spray 1130 by the casing 1140.

More specifically, as apparent from FIG. 4(b) or FIG. 5(b), each of the spraying mechanism 113 that makes up the first vaporizing and humidifying means 140 according to Example 2 and the spraying mechanism 113 that makes up the second vaporizing and humidifying means 130 according to Examples 3 or 4 is the spraying mechanism 113 incorporating the spray 1130. The spraying mechanism 113 of the first vaporizing and humidifying means 140 combines the spray 1130 with the blowing means 114 and the second filtration membrane 115. The spraying mechanism 113 of the second vaporizing and humidifying means 150 combines the spray 1130 with the suctioning mechanism 116 and the second filtration membrane 115.

For each of these sprays 1130 in all of Examples 2 to 4, the commercially available spray 1130 of AKI MIST-E03C, manufactured by H. IKEUCHI & CO., LTD. is used as shown in a table of FIG. 12. Each of the minute water droplets 20 therefrom has a maximum particle size of 50 μm and an average particle size of 10 μm or less. The blowing mechanism 114 and the second filtration membrane 115 according to Example 2 or the suctioning mechanism 116 and the second filtration membrane 115 according to Example 4 are both separated from the blowing mechanism or the suctioning mechanism and the filtration membrane used in BV-RTH1L, manufactured by Panasonic Corporation. Its blowing amount or suctioning amount is 11 m³/min. The suctioning mechanism 116 and the second filtration membrane 115 according to Example 3 is a commercially available AST-36-60 manufactured by NIPPON MUKI CO., LTD. Its suctioning amount is 36 m³/min. In addition, mesh roughness of the second filtration membrane is 0.3 μm/99.99% in the case according to Example 2 or 4, and is 3 μm/88% in the case according to Example 3.

As apparent from the spraying conditions shown in FIG. 9, the spraying conditions of Examples 2 to 4 are all 0.04 L/min, which is the same spraying condition as in Example 1. However, minute water droplets 20 from the spraying mechanism 113 of the first vaporizing and humidifying means 140 or the second vaporizing and humidifying means 150 are fed to the laminating part 100 by the blowing mechanism 114 of the first vaporizing and humidifying means 140 or the suctioning mechanism 116 of the second vaporizing and humidifying means 150, both via the second filtration membrane 115. Such technical means is not applied in Example 1. The apparent result is a wetting generated inside the laminating part 100 as shown in FIG. 9. While the humidified environments formed in each of the Examples has the same relative humidity of 70% at room temperature 22° C., generation of wetting after a long period of use of the laminating part 100 cannot be avoided in Example 1, whereas generation of wetting inside the laminating part 100 is not found in any of Examples 2 to 4.

It is because that, in the spraying mechanism 113 of Examples 2 to 4 is capable forming a humidified environment having relative humidity of 60 to 75% RH at room temperature 22° C. may be formed inside the laminating part 100 by spraying the minute water droplets 20 to the laminating part 100 by the spray 1130 with supply of water controlled, filtering the minute water droplets 20 blown or suctioned to the laminating part 100 by the blowing mechanism 114 or the suctioning mechanism 116 via the second filtration membrane 115, and further vaporizing the minute water droplets 20 filtered and adhered to the second filtration membrane 115 by the blowing mechanism 114 or the suctioning mechanism 116.

Next, the way of forming the humidified environment in the laminating part 100 configured to correspond to any of Examples 5 to 7 or any of Comparative Examples 3 to 6 is described in detail.

FIG. 6 is a diagrammatic illustration representing a laminating part 100 and a third vaporizing and humidifying means 170 of Examples 5 to 7 or Comparative Examples 3 to 6. As apparent from FIG. 6, configurations in common with the laminating part 100 according to Examples 1 to 4 are a plurality of air filtration means 120 comprising an intake mechanism 121 and a first filtration membrane 122 positioned on upper side of a top plate 130 of the laminating part 100, and a plurality of exhausting means 130 comprising an air outlet respectively provided on each of bottom plates 104 of the laminating part 100.

As apparent from FIG. 6 or FIGS. 9 and 10, the configuration is different from the laminating part 100 according to Examples 1 to 4 in that, a spraying mechanism 113 that makes up the third vaporizing and humidifying means 170 according to Examples 5 to 7 or Comparative Examples 3 to 6 is positioned outside the laminating part 100. More particularly, the spraying mechanism 113 that makes up the third vaporizing and humidifying means 170 is comprised of a spray 1130, and it is activated so as to form an environment with mist in upper air area of the plurality of air filtration means 120 positioned on the upper side of the top plate 103 of the laminating part 100.

Further, the air filtration means 120 positioned on upper surface of the top plate 103 takes in air of the environment with mist formed in the upper air area of the air filtration means 120 inside the laminating part 100 via the first filtration membrane 122 by the intake mechanism 121 such that the humidified environment is formed inside the laminating part 100. That is to say, it works in coordination with the spraying mechanism 113, and it has a function fundamentally different from a performance of the air filtration means 120 according to Examples 1 to 4.

The laminating part 100 according to Examples 5 to 7 or Comparative Examples 3 to 6 has a configuration different from the laminating part 100 according to Examples 1 to 4 in that the spray 1130 that makes up the spraying mechanism 113 of the third vaporizing and humidifying means 170 is positioned outside the laminating part 100 so as to work in coordination with the air filtration means 120. The spraying means 110 according to Example 1, the first vaporizing and humidifying means 140 according to Example 2 or the spraying mechanism 113 of the second vaporizing and humidifying means 150 according to Examples 3 or 4 are each positioned inside the laminating part 100.

As apparent from FIG. 6, minute water droplets 20 sprayed by the spray 1130 are fed inside the laminating part 100 via the first filtration membrane 122 by the intake mechanism 121 that makes up the air filtration means 120. That is to say, the intake mechanism 121 acts as a suctioning mechanism. The spraying condition of Example 5 is 0.04 L/min similar to the cases according to Examples 1 to 4, and the relative humidity of 70% RH at room temperature 22° C. is not changed. Therefore, similar to the cases according to Examples 1 to 4, it takes as quick as 41 seconds for attenuating (eliminating) static electrification of orientation disorder of the liquid crystal caused by static electrification in Example 5, and also similar to the cases according to Examples 1 to 4, no wetting is generated inside the laminating part 100 even after a long period of use. This is more effective than Example 1.

Comparative Example 4 contrasted with Example 5 is considered. In Comparative Example 4, the commercially available AST-36-60 manufactured by NIPPON MUKI CO., LTD. is adopted as the air filtering means 120 for the laminating part 100 in order to form such humidified environment. Its intake amount of the intake mechanism 121 that makes up the air filtration means 120 is 36 m³/min. Its performance is three times the intake amount of the intake mechanism 121 that makes up the air filtration means of Examples 1 to 4, which is 11 m³/min. Mesh roughness of 3 μm/88% is used for the first filtration membrane 122 that makes up the air filtration means 120 of Comparative Example 4. It is a roughness of about ten times the mesh roughness of the first filtration membrane 122 that makes up the air filtration means 120 of Examples 1 to 4, which is 0.3 μm/99.99%.

Next, when the spraying condition of a case according to Comparative Examples 3 or 4 is considered, each of the spraying conditions is 3.1 L/min which is greater than the spraying condition in the case of Example 5, which is 0.04 L/min, and it is the same as in the case according to Comparative Example 2 already considered. In both cases, the spray 1130 that makes up the spraying mechanism 113 is similarly positioned outside the laminating part 100 so as to work in coordination with air filtration means 120. In addition, in Comparative Example 3, BV-RTH1L manufactured by Panasonic Corporation which intake amount is set to 11 m³/min as in Examples 1 to 4 is used. In Comparative Example 4, AST-36-60 manufactured by NIPPON MUKI CO., LTD which intake amount is set to 11 m³/min is used. By the way, minute water droplets 20 fed to the first filtration membrane 122 are treated differently in that, in the case according to Comparative Example 3, the droplets are treated with the first filtration membrane 122 having mesh roughness of 0.3 μm/99.99%, whereas in the case according to Comparative Example 4, the droplets are treated with the first filtration membrane 122 having mesh roughness of 3 μm/88%, which is about ten times the mesh roughness of the membrane of Comparative Example 3.

In the case according to Comparative Examples 3 or 4, as shown in the table of FIG. 10, clogging occurs in the first filtration membrane 122, and relative humidity of the laminating part 100 at room temperature 22° C. is 50% RH and not reached to 60% RH. When the relative humidity at room temperature 22° C. is 60% RH or less, static electricity of the panel component cannot be eliminated sufficiently. In fact, in both cases, no wetting is generated inside the laminating part 100, but it takes as much as 124 or 125 seconds for attenuating (eliminating) orientation disorder of the liquid crystal caused by static electrification, which is about three times as the time of Example 1, and it is not a value which may be adopted in the continuous manufacturing process of the optical display device.

Examples 6 or 7 is considered. In the case according to Example 6, the spraying condition is set to 0.02 L/min so as to achieve 65% RH which is close to the minimum value of relative humidity at room temperature 22° C. In the case according to Example 7, the spraying condition is set to 0.05 L/min so as to achieve 75% RH which is the maximum value of relative humidity at room temperature 22° C. In both cases, other conditions are set the same as in the case according to Example 5. As a result, in both cases, clogging in the first filtration 122 membrane does not occur, and no wetting is generated inside the laminating part 100. In the case according to Example 6, it takes 83 seconds for attenuating (eliminating) orientation disorder of the liquid crystal caused by static electrification, which is a value close to the limit which may be adopted in the continuous manufacturing process of the optical display device. In the case according to Example 7, it takes 46 seconds which is a value which may be adopted without any problem in the continuous manufacturing process of the optical display device.

Comparative Examples 5 or 6 contrasted with Examples 5 to 7 is considered. The spraying condition in the case of Comparative Example 5 is set to 0.01 L/min. The spraying condition in the case of Comparative Example 6 is set to 0.06 L/min. Other conditions in both cases are set the same as in the cases according to Examples 5 to 7. As a result, in the case according to Comparative Example 5, relative humidity at room temperature 22° C. is 55% RH at a maximum, and it takes 120 seconds for attenuating (eliminating) orientation disorder of the liquid crystal caused by static electrification. In addition, in the case according to Comparative Example 6, relative humidity at room temperature 22° C. is 50% RH at a maximum. The experiment result in Comparative Example 6 is found as above despite the fact that the spraying condition is 0.06 L/min, which is six times more of the spray amount of that of in the case according to Comparative Example 5 in which spraying condition is 0.01 L/min.

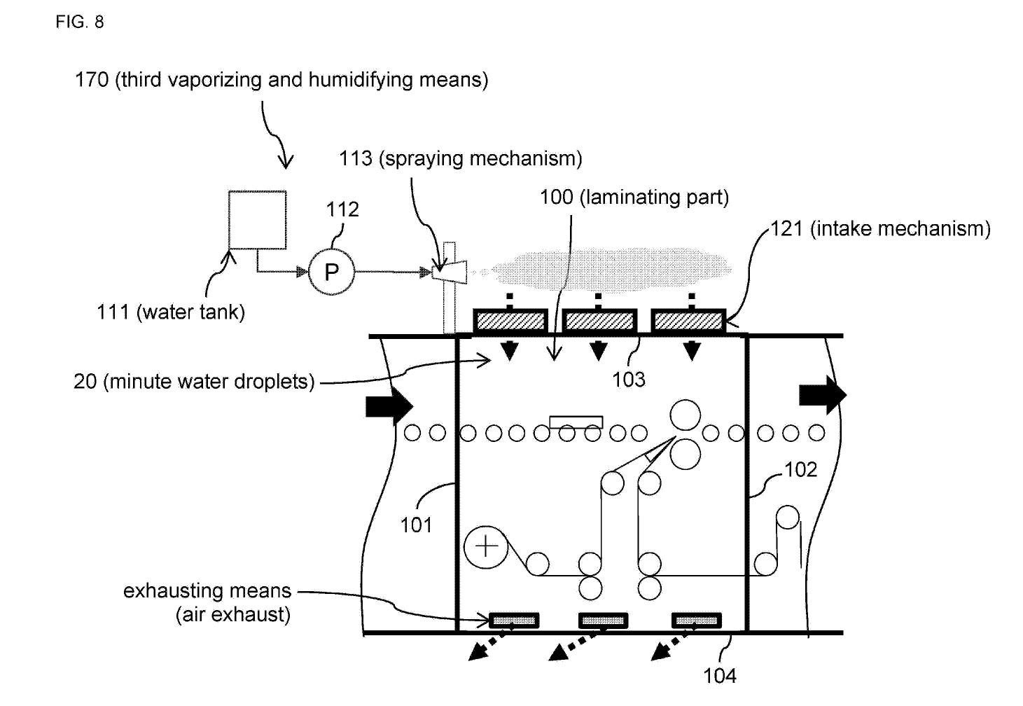

Further as shown in FIG. 8, Comparative Example 7 contrasted with Example 7 is considered. The spraying conditions are both 0.05 L/min, and the only difference between them is that the first filtration membrane 122 is removed in the case according to Comparative Example 7, and thus, the air filtration means 120 is configured only by the intake mechanism 121. For this reason, in Comparative Example 7, mesh-clogging problem in the first filtration membrane 122 does not occur, and thus, relative humidity at room temperature 22° C. reaches 80% RH. Because of this, it takes only 40 seconds for attenuating (eliminating) orientation disorder of the liquid crystal caused by static electrification. However, if the humidified environment is formed inside the laminating part 100, wetting is generated in a short period of time, and thus, it is difficult to be adopted as the continuous manufacturing method of the optical display device.

From the description above, and as apparent from Examples 1 to 7, the present invention allows continuous manufacturing of the optical display device 6 while eliminating electrical charge of the optical display device 6 caused by generation of static electricity in the optically functional film 1 or the optically functional film 1′ and/or the panel component 5 when continuously manufacturing the optical display device 6 by way of the following. A humidified environment is formed such that relative humidity becomes 60 to 75% RH when room temperature is 22° C., in at least one isolated laminating part 100 that makes up a part of the RTP laminating apparatus 10 or the sheet-type laminating apparatus 10′ for continuously manufacturing the optical display device 6 by laminating the optical functional film 1 or the optical functional film 1′ to the panel component 5. That is to say, the present invention is characterized in a method and apparatus for eliminating static electricity of the optical display device 6 in which electrostatic amount of the optical display device 6 statically electrified in a process of continuous manufacturing is quickly lowered in the humidified environment formed in the laminating part 100 of the RTP laminating apparatus 10 or the sheet-type laminating apparatus 10′.

### EXPLANATION OF NUMERICAL CHARACTERS

1: optical functional film
1′: optical functional film
2: carrier film
2′: separator
4: pressure-sensitive adhesive layer
5: panel component
6: optical display device
10: RTP laminating apparatus
10′: sheet-type laminating apparatus
11: web of laminate
11′: laminate sheet
20: minute water droplets
50: predetermined laminating position
60: peeling mechanism of RTP laminating apparatus
60′: peeling mechanism of sheet-type laminating apparatus
100: laminating part
101: upstream side
102: downstream side
103: top plate
104: bottom plate
110: spraying means
111: water tank
112: supply pump
113: spraying mechanism
1130: spray
1140: casing
114: blowing mechanism
115: second filtration membrane
116: suctioning mechanism
120: air filtration means
121: intake mechanism
122: first filtration membrane
130: exhausting means
140: first vaporizing and humidifying means
150: second vaporizing and humidifying means
170: third vaporizing and humidifying means
700: second laminating part
800: rotating and reversing part

1-32. (canceled)

33. A method for continuously manufacturing an optical display device, the method comprising:
a step of air filtering that takes outside air inside a laminating part via a first filtration membrane, the laminating part comprising one or more sidewalls defining an isolated space in an apparatus for continuously manufacturing the optical display device;
a step of exhausting that exhausts inside air outside the laminating part in coordination with the step of air filtering;
a step of humidifying the laminating part so as to make relative humidity of the laminating part as 60 to 75% RH at room temperature 22° C.;
a step of sequentially supplying a rectangularly formed optical functional film having a pressure-sensitive adhesive layer with a separator laminated on one of opposite surfaces of the optical functional film to a predetermined laminating position of the laminating part;
a step of conveying a rectangular panel component to the predetermined laminating position so as to correspond to the sequentially supplied optical functional film;
a step of peeling the separator from the optical functional film leaving the pressure-sensitive adhesive layer behind; and
a step of laminating the optical functional film to one of opposite surfaces of the panel component by the pressure-sensitive adhesive layer.

34. The method according to claim 33, wherein the laminating part is humidified by a spraying means that comprises a spraying mechanism inside the laminating part.

35. The method according to claim 33, the step of humidifying further comprises a step of spraying minute water droplets to the laminating part at 0.02 to 0.05 L/min, in which a maximum particle size is 50 μm or less and an average particle size is 10 μm or less.

36. The method according to claim 33, wherein the laminating part is humidified by a first vaporizing and humidifying means in the laminating part, wherein the first vaporizing and humidifying means comprises a spraying mechanism inside the laminating part, combined with a blowing mechanism and a second filtration membrane.

37. The method according to claim 36, wherein the step of humidifying further comprises a step of spraying minute water droplets to the laminating part at 0.02 to 0.05 L/min, in which a maximum particle size is 50 μm or less and an average particle size is 10 μm or less.

38. The method according to claim 33, wherein in that the laminating part is humidified by a second vaporizing and humidifying means in the laminating part, wherein the second vaporizing and humidifying means comprises a spraying mechanism inside the laminating part, combined with a suctioning mechanism and a second filtration membrane.

39. The method according to claim 38, the step of humidifying further comprises a step of spraying minute water droplets to the laminating part at 0.02 to 0.05 L/min, in which a maximum particle size is 50 μm or less and an average particle size is 10 μm or less.

40. The method according to claim 33, wherein the laminating part is humidified by a third vaporizing and humidifying means outside the laminating part, the third vaporizing and humidifying means comprises a spraying mechanism outside the laminating part and operates in coordination with the air filtration means.

41. The method according to claim 40, the step of humidifying further comprises a step of spraying minute water droplets to the laminating part at 0.02 to 0.05 L/min, in which a maximum particle size is 50 μm or less and an average particle size is 10 μm or less.

42. A method for continuously manufacturing an optical display device, the method comprising:
a step of air filtering that takes outside air inside a laminating part via a first filtration membrane, the laminating part comprising one or more sidewalls defining an isolated space in an apparatus for continuously manufacturing the optical display device;
a step of exhausting that exhausts inside air outside the laminating part in coordination with the step of air filtering;
a step of humidifying the laminating part so as to make relative humidity of the laminating part as 60 to 75% RH at room temperature 22° C.;
a step of peeling the optical functional film by feeding a web of laminate comprising a web of carrier film and a plurality of optical functional films with pressure-sensitive adhesive layers, rectangularly formed by forming slit lines in a width direction on one of opposite surfaces of the web of carrier film, to sequentially peel the optical functional film with the pressure-sensitive adhesive layer from the web of carrier film via a peeling mechanism positioned in proximity to a predetermined laminating position of the laminating part;
a step of sequentially supplying the sequentially peeled optical functional film with the pressure-sensitive adhesive layer to the predetermined laminating position;
a step of conveying a rectangular panel component to the predetermined laminating position so as to correspond to the sequentially supplied optical functional film with the pressure-sensitive adhesive layer; and
a step of laminating the optical functional film to one of opposite surfaces of the panel component by the pressure-sensitive adhesive layer.

43. The method according to claim 42, wherein the laminating part is humidified by a spraying means, the spraying means comprises a spraying mechanism inside the laminating part.

44. The method according to claim 42, the step of humidifying further comprises a step of spraying minute water droplets to the laminating part at 0.02 to 0.05 L/min, in which a maximum particle size is 50 μm or less and an average particle size is 10 μm or less.

45. The method according to claim 42, wherein the laminating part is humidified by a first vaporizing and humidifying means in the laminating part, the first vaporizing and humidifying means comprises a spraying mechanism inside the laminating part, combined with a blowing mechanism and a second filtration membrane.

46. The method according to claim 45, the step of humidifying further comprises a step of spraying minute water droplets to the laminating part at 0.02 to 0.05 L/min, in which a maximum particle size is 50 μm or less and an average particle size is 10 μm or less.

47. The method according to claim 45, the step of humidifying further comprises a step of supplying water in a controlled manner, a step of filtering the minute water droplets blown to the laminating part by the blowing mechanism via the second filtration membrane, and a step of vaporizing the filtered minute water droplets that are adhered to the second filtration membrane by the blowing mechanism.

48. The method according to claim 42, wherein the laminating part is humidified by a second vaporizing and humidifying means in the laminating part, the second vaporizing and humidifying means comprises a spraying mechanism inside the laminating part, combined with a suctioning mechanism and a second filtration membrane.

49. The method according to claim 48, wherein the step of humidifying comprises a step of spraying minute water droplets to the laminating part at 0.02 to 0.05 L/min, in which a maximum particle size is 50 μm or less and an average particle size is 10 μm or less.

50. The method according to claim 49, the step of humidifying further comprises a step of supplying water in a controlled manner, a step of filtering the minute water droplets taken in to the laminating part by the suctioning mechanism via the second filtration membrane, and a step of vaporizing the filtered minute water droplets that are adhered to the second filtration membrane by the suctioning mechanism.

51. The method according to claim 42, wherein the laminating part is humidified by a third vaporizing and humidifying means outside the laminating part, the third vaporizing and humidifying means comprises a spraying mechanism outside the laminating part and operates in coordination with the air filtration means.

52. The method according to claim 51, wherein the step of humidifying further comprises a step of spraying minute water droplets to the laminating part at 0.02 to 0.05 L/min, in which a maximum particle size is 50 μm or less and an average particle size is 10 μm or less.

53. The method according to claim 52, the step of humidifying further comprises a step of supplying water in a controlled manner, a step of filtering the minute water droplets taken in to the laminating part by the intake mechanism of the air filtration means via the first filtration membrane of the air filtration means, and a step of vaporizing the filtered minute water droplets that are adhered to the first filtration membrane by the intake mechanism.

54. An apparatus for continuously manufacturing an optical display device, the apparatus comprising:
a laminating part comprising one or more sidewalls defining an isolated space in the apparatus;
an air filtration means having an intake mechanism which takes in outside air inside the laminating part and a first filtration membrane;
an exhausting means which is installed in relation with the air filtration means to exhaust inside air outside the laminating part;
a humidifier for humidifying the laminating part so as to make relative humidity of the laminating part as 60 to 75% RH at room temperature 22° C.;
a supplying means to sequentially supply a rectangularly formed optical functional film having a pressure-sensitive adhesive layer with a separator laminated on one of opposite surfaces of the optical functional film to a predetermined laminating position of the laminating part;
a conveying means to convey a rectangular panel component to the predetermined laminating position so as to correspond to the sequentially supplied optical functional film;
a peeling means to peel the separator from the optical functional film leaving the pressure-sensitive adhesive layer behind; and
a laminating means to laminate the optical functional film to one of opposite surfaces of the panel component by the pressure-sensitive adhesive layer.

55. The apparatus according to claim 54, the humidifier further comprises the spraying mechanism that is configured to spray minute water droplets to the laminating part at 0.02 to 0.05 L/min, in which a maximum particle size is 50 μm or less and an average particle size is 10 μm or less.

56. The apparatus according to claim 54, the humidifier further comprises a first vaporizing and humidifying means and a spraying mechanism inside the laminating part, combined with a blowing mechanism and a second filtration membrane.

57. The apparatus according to claim 56, the humidifier further comprises the spraying mechanism that is configured to spray minute water droplets to the laminating part at 0.02 to 0.05 L/min, in which a maximum particle size is 50 μm or less and an average particle size is 10 μm or less.

58. The apparatus according to claim 54, the humidifier further comprises a second vaporizing and humidifying means and a spraying mechanism inside the laminating part, combined with a suctioning mechanism and a second filtration membrane.

59. The apparatus according to claim 58, the humidifier further comprises the spraying mechanism that is configured to spray minute water droplets to the laminating part at 0.02 to 0.05 L/min, in which a maximum particle size is 50 μm or less and an average particle size is 10 μm or less.

60. The apparatus according to claim 54, the humidifier further comprises a third vaporizing and humidifying means outside the laminating part, and a spraying mechanism outside the laminating part, capable of operating in coordination with the air filtration means.

61. The apparatus according to claim 60, the humidifier further comprises the spraying mechanism that is configured to spray minute water droplets to the laminating part at 0.02 to 0.05 L/min, in which a maximum particle size is 50 μm or less and an average particle size is 10 μm or less.

62. An apparatus for continuously manufacturing an optical display device, the apparatus comprising:
a laminating part comprising one or more sidewalls defining an isolated space in the apparatus;
an air filtration means having an intake mechanism which takes in outside air inside the laminating part and a first filtration membrane;
an exhausting means which is installed in relation with the air filtration means to exhaust inside air outside the laminating part;
a humidifier for humidifying the laminating part so as to make relative humidity of the laminating part as 60 to 75% RH at room temperature 22° C.;
a peeling means to peel the optical functional film by feeding a web of laminate comprising a web of carrier film and a plurality of optical functional film with pressure-sensitive adhesive layers, rectangularly formed by forming slit lines in a width direction on one of opposite surfaces of the web of carrier film, to sequentially peel the optical functional film with the pressure-sensitive adhesive layer from the web of carrier film via a peeling mechanism positioned in proximity to the predetermined laminating position of the laminating part;
a supplying means to sequentially supply the sequentially peeled optical functional film with the pressure-sensitive adhesive layer to the predetermined laminating position;
a conveying means to convey a rectangular panel component to the predetermined laminating position so as to correspond to the sequentially supplied optical functional film with the pressure-sensitive adhesive layer; and
a laminating means to laminate the optical functional film to one of opposite surfaces of the panel component by the pressure-sensitive adhesive layer.

63. The apparatus according to claim 62, the humidifier further comprises a spraying mechanism is configured to spray minute water droplets to the laminating part at 0.02 to 0.05 L/min, in which a maximum particle size is 50 μm or less and an average particle size is 10 μm or less.

64. The apparatus according to claim 62, the humidifier further comprises a first vaporizing and humidifying means in the laminating part and a spraying mechanism inside the laminating part, combined with a blowing mechanism and a second filtration membrane.

65. The apparatus according to claim 64, the humidifier further comprises a spraying mechanism is configured to spray minute water droplets to the laminating part at 0.02 to 0.05 L/min, in which a maximum particle size is 50 μm or less and an average particle size is 10 μm or less.

66. The apparatus according to claim 65, wherein the first vaporizing and humidifying means is configured to spray the minute water droplets to the laminating part by the spraying mechanism with a controlled supply of water, and the blowing mechanism is configured to blow the minute water droplets to the laminating part via the second filtration membrane, on which the filtered minute water droplets adhere and are configured to be vaporized.

67. The apparatus according to claim 62, the humidifier further comprises a second vaporizing and humidifying means and a spraying mechanism inside the laminating part, combined with a suctioning mechanism and a second filtration membrane.

68. The apparatus according to claim 67, the humidifier further comprises a spraying mechanism is configured to spray minute water droplets to the laminating part at 0.02 to 0.05 L/min, in which a maximum particle size is 50 μm or less and an average particle size is 10 μm or less.

69. The apparatus according to claim 68, wherein the second vaporizing and humidifying means is configured to spray the minute water droplets to the laminating part by the spraying mechanism with a controlled supply of water, and the suctioning mechanism is configured to suction the minute water droplets to the laminating part via the second filtration membrane, on which the filtered minute water droplets adhere and are configured to be vaporized.

70. The apparatus according to claim 62, the humidifier further comprises a third vaporizing and humidifying means outside the laminating part and a spraying mechanism outside the laminating part, configured to operate in coordination with the air filtration means.

71. The apparatus according to claim 70, the humidifier further comprises a spraying mechanism is configured to spray minute water droplets to the laminating part at 0.02 to 0.05 L/min, in which a maximum particle size is 50 μm or less and an average particle size is 10 μm or less.

72. The apparatus according to claim 71, wherein the third vaporizing and humidifying means is configured to spray the minute water droplets to the laminating part by the spraying mechanism with a controlled supply of water, and the intake mechanism of the air filtration means configured to intake the minute water droplets in to the laminating part via the first filtration membrane of the air filtration means, on which the filtered minute water droplets adhere and are configured to be vaporized.

73. The apparatus according to claim 54, wherein the panel component comprises a rectangular liquid crystal panel with electric components built therein, the optical functional film comprises a polarizing film having a rectangular-shaped pressure-sensitive adhesive layer so as to match with long sides or short sides of the rectangular liquid crystal panel, and the polarizing film is laminated to both opposite surfaces of the liquid crystal panel in a crossed-Nicol arrangement.

74. The apparatus according to claim 62, wherein the panel component comprises a rectangular liquid crystal panel with electric components built therein, the optical functional film comprises a polarizing film having a rectangular-shaped pressure-sensitive adhesive layer so as to match with long sides or short sides of the rectangular liquid crystal panel, and the polarizing film is laminated to both opposite surfaces of the liquid crystal panel in a crossed-Nicol arrangement.
